(19) United States
(12) Patent Application Publication
(10) Pub. No.: US 2024/0080724 A1
(43) Pub. Date: Mar. 7, 2024

(54) ELECTRONIC EQUIPMENT AND METHOD THEREOF

(71) Applicant: SAMSUNG ELECTRONICS CO., LTD., Suwon-si, Gyeonggi-do (KR)

(72) Inventors: Weiwei Wang, Suwon-si (KR); Hong Wang, Suwon-si (KR); Lixiang Xu, Suwon-si (KR)

(21) Appl. No.: 18/262,673

(22) PCT Filed: Jan. 21, 2022
(86) PCT No.: PCT/KR2022/001146

§ 371 Date: Jul. 24, 2023

(30) Foreign Application Priority Data
Jan. 22, 2021 (CN) 202110088059.0

(51) Int. Cl. H04W 36/00; H04W 36/08

(52) U.S. Cl. CPC H04W 36/0069; H04W 36/08

(57) ABSTRACT

The disclosure relates to a 5G or 6G communication system for supporting a higher data transmission rate. The present application provides nodes, user equipment and methods performed by the same in a wireless communication system. The method performed by a node includes: transmitting, to a target node connected by the user equipment, a first message including information related to user equipment configuration; receiving, from the target node, a second message including configuration information on the target node; transmitting, to a source node connected by the user equipment, a fourth message is used to configure the source node to perform data transmission with the user equipment in a procedure of change of the node connected by the user equipment.

### TECHNICAL FIELD

The application relates to a wireless communication technology, in particular to a mechanism for establishing multi-connectivity of a user equipment, including an electronic equipment in a wireless communication system and a method thereof.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

In the New Radio (NR) access network, Dual-Connectivity technology may improve the throughput of the user equipment, that is, one user equipment may be served by two different base stations or two different distributed units of one base station. In addition, in order to reduce the service interruption of the user equipment in a handover procedure, the NR has also proposed a Dual-Active Protocol Stack (DAPS) handover technology, which allows the user equipment to still maintain communication with a source base station in the handover procedure to a target base station.

### DISCLOSURE OF INVENTION

### Technical Problem

For the Dual-Connectivity technology and DAPS handover technology, the current design assumes that one user equipment performs data transmission with two nodes or two distributed units at most. This limitation may result in the loss of data throughput of the user equipment. For example, in the case of dual connectivity, the user equipment needs to interrupt the communication with a source secondary node when a secondary node change occurs for the user equipment, or the user equipment needs to interrupt the communication with the secondary node when the master node handovers in case of no secondary node change occurs for the user equipment, which leads to the interruption of data transmission on these nodes, and thus reduce the throughput of the user equipment. Therefore, in one aspect, the present invention aims at overcome the above problems.

For another example, as the frequency serving user equipment increases, there may be more than two nodes that can serve the user equipment in an area. However, due to the limitation of the traditional technology, the user equipment can only maintain communication with two of the nodes. If a serving node is to be changed, it is necessary to carry out a handover procedure or a secondary node change procedure, which greatly increases the signaling overhead for changing the serving node, and this change procedure will also lead to an interruption of data transmission of the user equipment, so the traditional technology will also lead to reduction of the data throughput of the user equipment. On the other hand, the present invention also aims at overcoming the above problems, allowing the user equipment to maintain communication with a plurality of nodes, and ensuring continuity of user data transmission by dynamically changing the serving node among the plurality of nodes, improving the throughput of the user equipment, and reducing the signaling overhead in the procedure of changing the serving node for the user equipment.

### Solution to Problem

According to an aspect of the invention, there is provided a method performed by a first node in a wireless communication system, including: transmitting a first message to a third node; receiving a second message from the third node; transmitting a fourth message to a second node; and receiving a fifth message from the second node, wherein the first node is a node connected by a user equipment in multi-connectivity, the second node is a source node connected by the user equipment, and the third node is a target node connected by the user equipment, and wherein the first message includes information related to user equipment configuration, the second message includes configuration information on the third node side, the fourth message is used to configure the second node to perform data transmission with the user equipment in a procedure of change of the node connected by the user equipment, and the fifth message includes configuration information related to user data transmission at the second node.

According to another aspect of the invention, there is provided a method performed by a second node in a wireless communication system, including: receiving a fourth message from a first node; and transmitting a fifth message to the first node, a first message being transmitted from the first node to a third node, a second message being transmitted from the third node to the first node, wherein the first node is a node connected by a user equipment in multi connectivity, the second node is a source node connected by the user equipment, and the third node is a target node connected by the user equipment, and wherein the first message includes information related to user equipment configuration, the second message includes configuration information on the third node side, the fourth message is used to configure the second node to perform data transmission with the user equipment in a procedure of change of the node connected by the user equipment, and the fifth message includes configuration information related to user data transmission at the second node.

According to another aspect of the invention, there is provided a method performed by a third node in a wireless communication system, including: receiving a first message from a first node; and transmitting a second message to the first node, a fourth message being transmitted from the first node to a second node, a fifth message being transmitted from the second node to the first node, wherein the first node is a node connected by a user equipment in multi connectivity, the second node is a source node connected by the user equipment, and the third node is a target node connected by the user equipment, and wherein the first message includes information related to user equipment configuration, the second message includes configuration information on the third node side, the fourth message is used to configure the second node to perform data transmission with the user equipment in a procedure of change of a node connected by the user equipment, and the fifth message includes configuration information related to user data transmission at the second node.

In the method according to an example embodiment of the present invention, the first message may include at least one of the following information: information for requesting the third node that the user equipment still performs data transmission with the second node, information for requesting forwarding data to the third node, and first configuration information related to user data; the second message may include at least one of the following information: information for indicating whether the third node accepts the request, configuration information generated by the third node for data transmission required by the user equipment, and second configuration information related to user data; the fourth message may include at least one of the following information: indication information of data transmission behavior and third configuration information related to user data; and the fifth message may include fourth configuration information related to user data.

The method by the first node according to an example embodiment of the present invention may further include receiving, from the third node, a third message for indicating that the user equipment has accessed the third node.

The method by the third node according to an example embodiment of the present invention may further include transmitting, to the first node, a third message for indicating that the user equipment has accessed the third node.

According to another aspect of the invention, there is provided a method performed by a fourth node in a wireless communication system, including: transmitting a sixth message to a fifth node; and receiving a seventh message from the fifth node, wherein the sixth message is used to request for information related to data transmission or to configure transmission of data, and the seventh message is used to provide information related to data transmission or provide information related to transmitted data.

According to another aspect of the invention, there is provided a method performed by a fifth node in a wireless communication system, including: receiving a sixth message from a fourth node; and transmitting a seventh message to the fourth node, wherein the sixth message is used to request for information related to data transmission or to configure transmission of data, and the seventh message is used to provide information related to data transmission or provide information related to transmitted data.

In the method according to an example embodiment of the present invention, the sixth message may include at least one of information for requesting the fifth node to provide information related to data forwarding and information for configuring forwarding of user data, and the seventh message may include at least one of information for providing information related to receipt of the forwarded data and information for indicating information related to data forwarded by the fifth node.

According to another aspect of the invention, there is provided a method performed by a sixth node in a wireless communication system, including: transmitting an eighth message to a seventh node; and receiving a ninth message from the seventh node, wherein the sixth node and the seventh node are two of nodes serving a user equipment, and wherein the eighth message is used to request for acquiring configuration information for serving the user equipment at the seventh node and/or providing configuration information of other nodes serving the user equipment to the seventh node, and the ninth message includes configuration information for serving the user equipment on the seventh node side.

According to another aspect of the invention, there is provided a method performed by a seventh node in a wireless communication system, including: receiving an eighth message from a sixth node; and transmitting a ninth message to the sixth node, wherein the sixth node and the seventh node are two of nodes serving a user equipment, and wherein the eighth message is used to request for acquiring configuration information for serving the user equipment at the seventh node and/or providing configuration information of other nodes serving the user equipment to the seventh node, and the ninth message includes configuration information for serving the user equipment on the seventh node side.

In the method according to an example embodiment of the present invention, the eighth message may include at least one of information for requesting the seventh node to provide configuration information related to data transmission, information for providing configuration information required for data transmission to the seventh node and information for providing configuration information related to transmitted data, and the ninth message may include at least one of information for indicating configuration information used by the seventh node to transmit data and information for indicating configuration information related to data transmitted by the seventh node.

According to another aspect of the invention, there is provided a method performed by an eighth node in a wireless communication system, including: transmitting a tenth message to a ninth node; and receiving an eleventh message from the ninth node, wherein the tenth message is used for transmitting configuration information related to a plurality of nodes serving a user equipment, so that the ninth node operates according to the received configuration information.

According to another aspect of the invention, there is provided a method performed by a ninth node in a wireless communication system, including: receiving a tenth message from an eighth node; and transmit an eleventh message to the eighth node, wherein the tenth message is used for transmitting configuration information related to a plurality of nodes serving a user equipment, the ninth node operates according to the received configuration information.

In the method according to an example embodiment of the present invention, the tenth message may include at least one of the following information: user data indication information, indication information of serving user equipment, indication information of not serving user equipment, indication information of activating a node, indication information of deactivating a node, indication information of activating a cell group, indication information of deactivating a cell group, indication information of activating a cell, indication information of deactivating a cell, indication information of a node serving a user equipment, indication information of a cell group serving a user equipment, indication information of a cell serving a user equipment, indication information of a data transmission tunnel and data forwarding indication information.

According to another aspect of the invention, there is provided a method performed by a tenth node in a wireless communication system, including: transmitting a twelfth message to a user equipment, wherein the twelfth message is used to configure the user equipment, so that the user equipment performs data transmission with a designated node according to the received configuration information.

According to another aspect of the invention, there is provided a method performed by a user equipment in a wireless communication system, including: receiving a twelfth message from a tenth node; and performing data transmission with a designated node according to the received configuration information, wherein the twelfth message is used to configure the user equipment.

In the method according to an example embodiment of the present invention, the twelfth message may include at least one of the following information: data identification information, configuration information of a cell or a cell group serving the user equipment, and configuration information of a node serving the user equipment.

According to another aspect of the present invention, there is provided a method performed by a first distribution unit in a wireless communication system, including: transmitting a thirteenth message to a second distribution unit, wherein the thirteenth message is used to transmit user data and/or configuration information related to transmission of the user data.

According to another aspect of the present invention, there is provided a method performed by a second distribution unit in a wireless communication system, including: receiving a thirteenth message from a first distribution unit, wherein the thirteenth message is used to transmit user data and/or configuration information related to transmission of the user data.

In the method according to the example embodiment of the present invention, the thirteenth message may include at least one of the following information: a data packet of a user equipment, indication information of a last data packet, information related to discarded data packet, and activation indication information. According to another aspect of the present invention, there is provided an electronic device including: a memory for storing a computer program; and a controller configured to execute the computer program to implement the method of the present invention. The electronic device may be a node, a distributed unit of a node, or a user equipment.

### Advantageous Effects of Invention

The present invention provides a method for communicating efficiently using the Dual-Connectivity technology and DAPS handover technology.

### BRIEF DESCRIPTION OF DRAWINGS

FIG. 1 is an exemplary system architecture according to various embodiments of the disclosure.

FIG. 2 is an exemplary structure of a base station according to various embodiments of the present disclosure.

FIG. 3 is a schematic diagram of a dual-connectivity technique according to various embodiments of the present disclosure.

FIG. 4 shows a schematic diagram of a scenario of a mobile communication system according to an example embodiment of the present disclosure.

FIG. 5 shows a schematic diagram of a change of a serving node for a user equipment.

FIG. 6 is a schematic diagram showing a change of the node to which a user equipment is connected, in the case of dual connectivity (or multi connectivity), according to an example embodiment of the present disclosure.

FIG. 7 is an example process between nodes that may be involved in the mechanism of node change in a multi-connectivity scenario according to an example embodiment of the present disclosure.

FIG. 8 is another example process between nodes that may be involved in the mechanism of node change in a multi-connectivity scenario according to an example embodiment of the present disclosure.

FIG. 9 is another example process between nodes that may be involved in the mechanism of node change in a multi-connectivity scenario according to an example embodiment of the present disclosure.

FIG. 10 is another example process between nodes that may be involved in the mechanism of node change in a multi-connectivity scenario according to an example embodiment of the present disclosure.

FIG. 11 is another example process between nodes and a user equipment that may be involved in the mechanism of node change in a multi-connectivity scenario according to an example embodiment of the present disclosure.

FIG. 12 is another example process between nodes and a user equipment that may be involved in the mechanism of node change in a multi-connectivity scenario according to an example embodiment of the present disclosure.

FIG. 13 is a schematic diagram of dynamic change of a serving node in a multi-connectivity scenario according to an example embodiment of the present disclosure.

FIG. 14 is an example process between nodes that may be involved in a method for dynamically changing a serving node in a multi-connectivity scenario according to an example embodiment of the present disclosure.

FIG. 15 is another example process between nodes that may be involved in the method for dynamically changing a serving node in a multi-connectivity scenario according to an example embodiment of the present disclosure.

FIG. 16 is an example process of configuring a user equipment according to an example embodiment of the present disclosure.

FIG. 17 is a schematic diagram of data forwarding between distributed units of a base station according to an example embodiment of the present disclosure.

FIG. 18 is an example process involved in forwarding data between distributed units of a base station according to an example embodiment of the present disclosure.

FIG. 19 is a block diagram of a node according to an example embodiment of the present disclosure.

FIG. 20 is a block diagram of a user equipment according to an example embodiment of the present disclosure.

### MODE FOR THE INVENTION

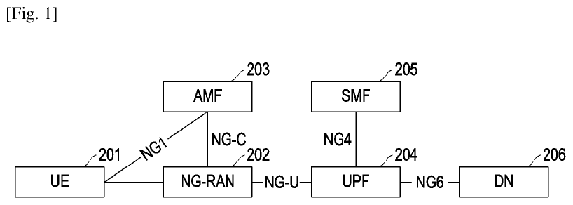

FIGS. 1 to 20 discussed below and various embodiments for describing the principles of the present disclosure in this patent document are only for illustration and should not be interpreted as limiting the scope of the disclosure in any way. Those skilled in the art will understand that the principles of the present disclosure may be implemented in any suitably arranged system or device.

FIG. 1 is an exemplary system architecture according to various embodiments of the present disclosure. Other embodiments of the system architecture can be used without departing from the scope of this disclosure.

User equipment (UE) 201 is a terminal device for receiving data. The next generation radio access network (NG-RAN) 202 is a radio access network, which includes a base station (gNB or an eNB connected to 5GC of 5G core network, and the eNB connected to 5GC is also called ng-gNB) that provides UE with access to the radio network interface. The access and mobility management functional entity (AMF) 203 is responsible for managing the mobility context and security information of the UE. The user plane function entity (UPF) 204 mainly provides the functions of the user plane. Session management functional entity SMF 205 is responsible for session management. Data (DN) 206 includes services of operators, access to the Internet, services of third parties, and so on.

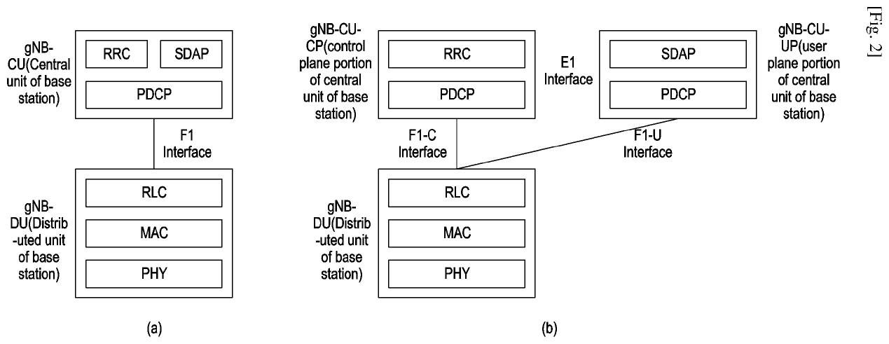

FIG. 2 is an exemplary structure of a base station according to various embodiments of the present disclosure.

In an NR system, in order to support network function virtualization and more efficient resource management and scheduling, a base station (gNB) providing a wireless network interface for user equipment (UE) may be further divided into a central unit, gNB-CU (gNB-central unit) and a distributed unit gNB-DU (gNB-distributed unit), (abbreviated as CU and DU in the present invention), as shown in (a) of FIG. 2. The CU has Radio Resource Control (RRC), Service Data Adaptation Protocol (SDAP) and Packet Data Convergence Protocol (PDCP) layers, etc. The DU has Radio Link Control (RLC), Media Access Control (MAC) and Physical (PHY) layers, etc. Between the CU and the DU, there is a public F1 interface which is standardized. The F1 interface is divided into a control plane F1-C interface and a user plane F1-U interface. The transmission network layer of F1-C interface is for transmission based on Internet Protocol (IP). In order to transmit signaling more reliably, Stream Control Transmission Protocol (SCTP) is added over the IP. The protocol of the application layer is F1AP, see 3GPP TS38.473. SCTP may provide reliable application layer message transmission. The transport layer of F1-U interface is User Datagram Protocol (UDP)/IP, and General packet radio service (GPRS) TunnelingProtocol-User plane (GTP-U) over the UDP/IP is used to carry the Protocol Data Unit (PDU) of the user plane. Furthermore, as shown in (b) of FIG. 2, the gNB-CU may include a gNB-CU-CP (a control plane portion of the central unit of the base station) and a gNB-CU-UP (a user plane portion of the central unit of the base station), in which gNB-CU-CP includes the control plane function of the base station and has RRC and PDCP protocol layers, and gNB-CU-UP includes the user plane function of the base station and has SDAP and PDCP protocol layers. Between gNB-CU-CP and gNB-CU-UP, there is a public E1 interface which is standardized, and the protocol is E1AP, see 3GPP TS38.463. The interface between control plane portion of the central unit and the distributed unit of the base station is an F1-C interface, namely, the control plane interface of F1, and the interface between user plane portion of the central unit and the distributed unit of the base station is an F1-U interface, namely, the user plane interface of F1.

FIG. 3 is a schematic diagram of a dual-connectivity technique according to various embodiments of the present disclosure.

In order to improve the throughput of the user equipment, Long Term Evolution (LTE) and NR systems propose the technology of dual connectivity. In this technology, as shown in FIG. 3, the user equipment may communicate with two base stations (as shown in (a) of FIG. 3) or two distributed units of a base station (as shown in (b) of FIG. 3). When the base station or distributed unit serving the user equipment changes, the user equipment needs to disconnect communication with the old base station or distributed unit first, and then establish a connection with a new base station or distributed unit. In this procedure, the transmission of user data will be interrupted, thus reducing the throughput of the user equipment. In the present application, the old base station may also be called a source base station or a source node, and the new base station may also be called a target base station or a target node.

In order to avoid the communication interruption occurring in the user equipment in the handover procedure, the LTE proposed a make-before-break handover, and the NR has proposed a Dual-Active Protocol Stack (DAPS) handover. The principle of these handover mechanisms is that the user equipment may maintain communication with the source node when performing the handover procedure, and then disconnect the communication with the source node after the user equipment completely accesses the target node. In this procedure, the communication of the user equipment can be maintained uninterrupted. However, this mechanism cannot be applied to dual-connectivity technology, because the current technology assumes that one user equipment can perform data transmission with only two base stations or two distributed units at most.

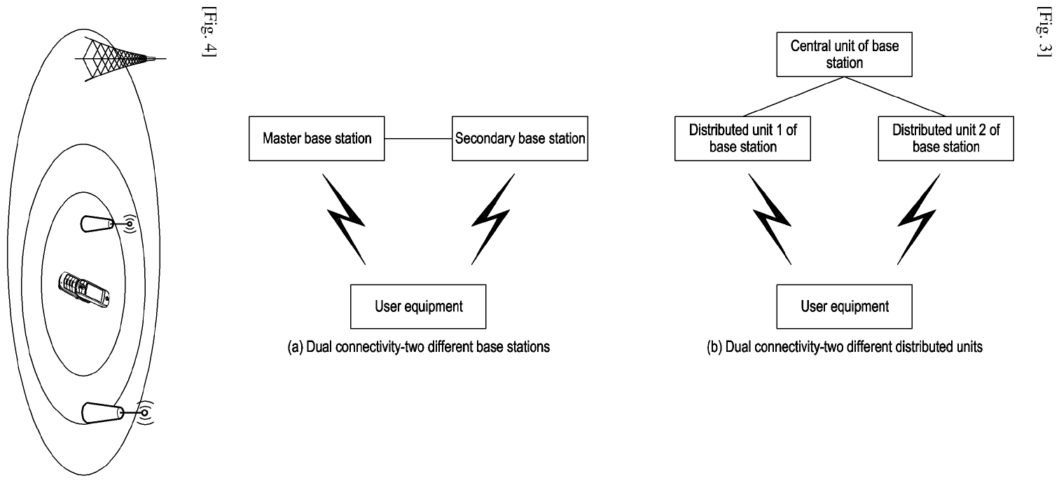

FIG. 4 shows a schematic diagram of a scenario of a mobile communication system according to an example embodiment of the present disclosure.

With the increasing shortage of spectrum resources, mobile communication systems begin to consider using higher frequencies to realize data transmission of user equipment, which may lead to one user equipment being located in the coverage of multiple base stations or distributed units, as shown in FIG. 4, one user equipment may be located in the coverage of three base stations. Assuming that one user equipment may perform data transmission with only two base stations or two distributed units at most, in the scenario shown in FIG. 4, the network side needs to perform the base station handover process or the secondary node change process or the distributed unit change process in order to change the serving node for the user equipment. On the one hand, this procedure leads to the interruption of user data transmission, and on the other hand, it also leads to more signaling overhead and time delay of node change. Therefore, the traditional technology will cause the decrease of throughput in the serving node change procedure. To solve this problem, the present invention proposes the following three mechanisms:

Mechanism of Node Change in Multi-Connectivity Scenario

Mechanism and Method of Dynamic Change of Serving Nodes in Multi-Connectivity Scenario

Mechanism for Forwarding Data Between Distributed Units of a Base Station

Before introducing the specific content, some assumptions and some definitions of the present invention are given below.

The message names in the present invention are only examples, and other message names may also be used.

The “first”, “second”, etc. contained in the message names of the present invention are only used to distinguish one message from another, and do not represent the execution order and importance.

Detailed description of steps unrelated to the present invention is omitted in the present invention.

In the present invention, the base station may be a 5G base station (such as gNB), a 4G base station (such as eNB), or other types of access nodes.

In the present invention, data transmission includes data reception or transmission, and data forwarding.

First Aspect: A Mechanism of Node Change in Multi-Connectivity Scenario

One user equipment maintains connection with at least two base stations (such as base station 1, base station 2, base station 3, . . . ) or at least two distributed units (distributed unit 1, distributed unit 2, distributed unit 3, . . . , which may be connected to the same central unit or different central units), and these base stations or distributed units connected with the user equipment may change. The scenario considered in the first aspect is that at least one of the base stations or distributed units connected with the user equipment has changed.

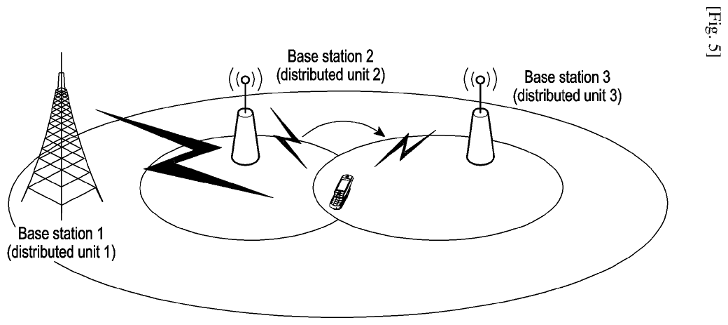

FIG. 5 shows a schematic diagram of a change of a serving node for one user equipment according to an example embodiment of the present disclosure, in which the user equipment maintains connection with base station 1 and base station 2, and then the base station 2 connected with the user equipment becomes base station 3; or, the user equipment maintains connection with the distributed unit 1 and the distributed unit 2, and then the distributed unit 2 connected with the user equipment becomes the distributed unit 3. Nodes involved in the invention include:

First node: one node to which the user equipment is connected, which may be a base station or a distributed unit of the base station. In one embodiment, the base station may be a master base station in a dual connectivity, in another embodiment, the base station may be a secondary base station in a dual connectivity, in another embodiment, the base station may be one base station in a multi-connectivity (the user equipment maintains connections with multiple base stations), in another embodiment, the base station may be a master base station in multi-connectivity (user equipment maintains connection with multiple base stations), in another embodiment, the base station may be a secondary base station in multi-connectivity (user equipment maintains connection with multiple base stations), and in another embodiment, the node may be a distributed unit to which the user equipment is connected

Second node: another node, different from the first node, to which the user equipment is connected, which may be a base station or a distributed unit of the base station. In one embodiment, the base station may be a secondary base station in dual connectivity, in another embodiment, the base station may be a master base station in dual connectivity, in another embodiment, the base station may be one base station in multi-connectivity (the user equipment maintains connections with multiple base stations), in another embodiment, the base station may be a secondary base station in multi-connectivity (the user equipment maintains connections with multiple base stations), in another embodiment, the base station may be a master base station in a multi-connectivity (the user equipment maintains connection with multiple base stations), in another embodiment, the node may be one distributed unit connected with the user equipment, and in another embodiment, the node may be a source node connected with the user equipment

Third node: another node, different from the first node and the second node, to which the user equipment is connected, which may be a base station, or may be a distributed unit of the base station. In one embodiment, the base station may be a secondary base station in dual connectivity, in another embodiment, the base station may be a master base station in dual connectivity, in another embodiment, the base station may be one base station in multi-connectivity (user equipment maintains connections with multiple base stations), in another embodiment, the base station may be a secondary base station in multi-connectivity (user equipment maintains connection with multiple base stations), in another embodiment, the base station may be a master base station in multi-connectivity (user equipment maintains connection with multiple base stations), in another embodiment, the node may be one distributed unit connected with the user equipment, and in one embodiment, the node may be a target node connected with the user equipment

Furthermore, when at least one node connected with the user equipment changes, the first node is an unchanged node, the second node is a node (source node) to which the user equipment is connected before the node changes, and the third node is a node (target node) to which the user equipment is connected after the node changes.

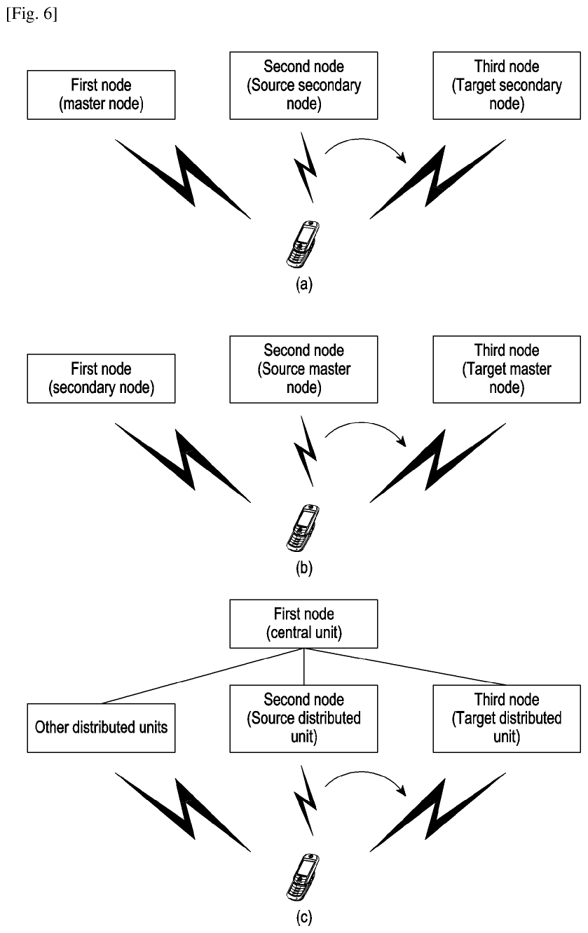

FIG. 6 is a schematic diagram of a change of the node to which a user equipment is connected, in the case of dual connectivity (or multi connectivity) according to an example embodiment of the present disclosure.

In an implementation, as shown in (a) of FIG. 6, the first node is a master node to which the user equipment is connected in the case of dual connectivity (or multi connectivity), the second node (source secondary node) is a secondary node to which the user equipment is connected and has changed, and the third node is a new secondary node (target secondary node) to be connected after the secondary node to which the user equipment is connected has changed, that is, the secondary node to which the user equipment is connected has changed from the second node to the third node.

In another implementation, as shown in (b) of FIG. 6, the first node is a secondary node to which the user equipment is connected in the case of dual connectivity (or multi connectivity), the second node (source master node) is a master node to which the user equipment is connected and has changed, and the third node is a new master node (target master node) to be connected after the master node to which the user equipment is connected has changed, that is, the master node to which the user equipment is connected has changed from the second node to the third node.

In another implementation, as shown in (c) of FIG. 6, the user equipment maintains connection with at least two distributed units under one central unit, the first node is a central unit, the second node is one distributed unit (source distributed unit) to which the user equipment is connected and has changed, and the third node is a new distributed unit (target distributed unit) to be connected after the node has changed. Furthermore, in this implementation, the distributed unit to which the user equipment is connected at least further includes other distributed units different from the second node and the third node.

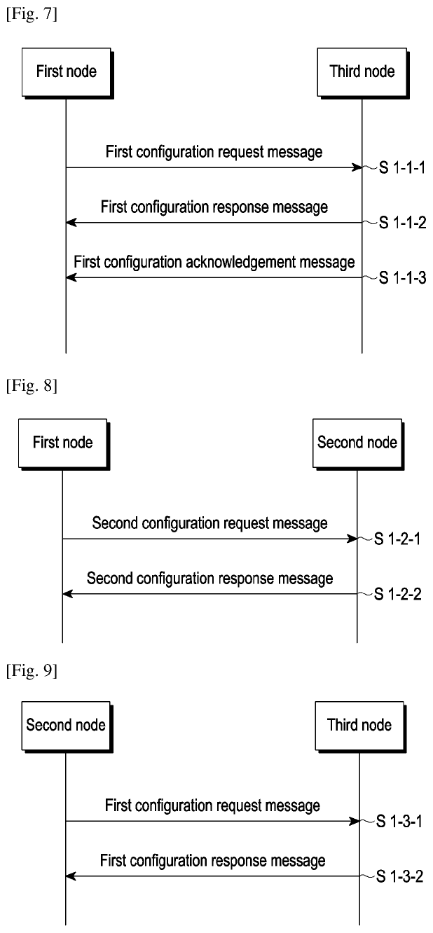

In the first aspect of the present invention, one node to which the user equipment is connected changes from the above second node to the third node. In this procedure, the user equipment will maintain the connection with the first node and the second node, and carry out data transmission (including transmission or reception) with these two nodes, and after the user equipment establishes a connection with the third node, the user equipment will disconnect from the second node, and further, in this procedure, the user equipment may still maintain the connection with the first node. Furthermore, in this embodiment, the user equipment may also maintain the connection with other nodes. To achieve this, an example embodiment of the present invention may include the following processes:
1) Process 1: the process between the first node and the third node. FIG. 7 is an example process between nodes that may be involved in the mechanism of node change in a multi-connectivity scenario according to an example embodiment of the present disclosure. As shown in FIG. 7, the process may include the following steps:

Step 1-1-1: The first node transmits a first message to the third node. The first message may be a first configuration request message. The third node is a new node accessed by the user equipment. Therefore, the first configuration request message is used to provide the third node with information related to the configuration of the user equipment. The message may include at least one of the following information:

First transmission request information, which is used to indicate that the first node requests that the user equipment will also perform data transmission (including receiving and/or transmitting data) with other nodes (such as the second node and/or the first node) during the access to the third node by the user equipment, and the transmitted data may be all data served by the third node. After receiving the indication, the third node may determine whether to accept the request, and then generate information for configuring the user equipment. In an embodiment, when the user equipment is in dual connectivity, the data targeted by the above-mentioned “first transmission request information” may be the Master Node (MN)-terminated Secondary Cell Group (SCG) bearer and/or the MN-terminated split bearer, and/or the Secondary Node (SN)-terminated SCG bearer, and/or the SN-terminated split bearer

First forwarding request indication information, which is used to request forwarding data to the third node. The information includes at least one of the following information:

First request information for forwarding downlink data, which is used to request the configuration required when other nodes (such as the second node) forward downlink data to the third node

First request information for forwarding uplink data, which is used to request the configuration required when other nodes (such as the second node) forward uplink data to the third node

First request information for inter-DU data forwarding, which is used to request the configuration required when other nodes (such as the second node or the distributed unit of the second node) forward data to the distributed unit of the third node, or request the configuration required when other nodes (such as the second node or the distributed unit of the second node) forward data to the third node

First request information for inter-DU downlink data forwarding, which is used to request the configuration required when other nodes (such as the second node or the distributed unit of the second node) forward downlink data to the distributed unit of the third node, or request the configuration required when other nodes (such as the second node or the distributed unit of the second node) forward downlink data to the third node

First request information for inter-DU uplink data forwarding, which is used to request the configuration required when other nodes (such as the second node or the distributed unit of the second node) forward uplink data to the distributed unit of the third node, or request the configuration required when other nodes (such as the second node or the distributed unit of the second node) forward uplink data to the third node

First configuration information related to user data, which is used to inform the third node of the configuration information related to user data, and to generate, by the third node, configuration information of the user equipment. The information may include at least one of the following information:

Data identification information, which identifies the data of the user equipment, with the data being the data that needs to be served by the third node after the user equipment accesses the third node; in one embodiment, if the data is a PDU session of the user equipment, the identification information is an identification of the PDU session; in another embodiment, if the data is a QoS flow of the user equipment, the identification information is an identification of the QoS flow; in another embodiment, if the data is a radio bearer of the user equipment (such as a Data Radio Bearer (DRB)), the identification information is an identification of the RB

Information related to data mapping, which is mapping information used when helping the third node generate the configuration of user data, and the data may be the data indicated by the above-mentioned “data identification information”. In an embodiment, the information indicates the mapping relationship between QoS flow and DRB at other nodes (such as the second node). Specifically, the information includes a DRB ID, and identification information of one or more QoS flows mapped to DRB indicated by the DRB ID and/or uplink and downlink indication information. After receiving the information, the third node may generate the configuration of DRB according to the mapping relationship

First data transmission request information, which is used to indicate that the user equipment will also perform data transmission (including receiving and/or transmitting data) with other nodes (such as the second node and/or the first node) during the access procedure to the third node by the user equipment, and the transmitted data is the data indicated by the above-mentioned “data identification information”. After receiving the indication, the third node may determine whether to accept the request, and then generate information for configuring the user equipment

First data forwarding request indication information, which is used to request the configuration required when other nodes (such as the second node or the distributed unit of the second node) forward data to the third node, and the forwarded data may be the data indicated by the above-mentioned “data identification information”. The information may include at least one of the following information:

First request information for forwarding the user downlink data, which is used to request the configuration required when other nodes (such as the second node or the distributed unit of the second node) forward the downlink data to the third node

First request information for forwarding the user uplink data, which is used to request the configuration required when other nodes (such as the second node or the distributed unit of the second node) forward the uplink data to the third node

First request information for inter-DU user data forwarding, which is used to request the configuration required when other nodes (such as the second node or the distributed unit of the second node) forward data to the distributed unit of the third node, or request the configuration required when other nodes (such as the second node or the distributed unit of the second node) forward data to the third node

First request information for inter-DU uplink user data forwarding, which is used to request the configuration required when other nodes (such as the second node or the distributed unit of the second node) forward uplink data to the distributed unit of the third node, or request the configuration required when other nodes (such as the second node or the distributed unit of the second node) forward uplink data to the third node

First request information for inter-DU downlink user data forwarding, which is used to request the configuration required when other nodes (such as the second node or the distributed unit of the second node) forward downlink data to the distributed unit of the third node, or request the configuration required when other nodes (such as the second node or the distributed unit of the second node) forward downlink data to the third node

First configuration information for forwarding data, which indicates the configuration of the data to be forwarded, and may include at least one of the following information:

Maximum identification information of forwarded data, which indicates a maximum sequence number of the data packet forwarded to the third node. In an embodiment, the data is forwarded to the distributed unit of the third node (such as from the distributed unit of the second node to the distributed unit of the third node)

Maximum identification information of forwarded downlink data, which indicates a maximum sequence number of the downlink data packet forwarded to the third node. In an embodiment, the data is forwarded to the distributed unit of the third node (such as from the distributed unit of the second node to the distributed unit of the third node)

Maximum identification information of forwarded uplink data, which indicates a maximum sequence number of the uplink data packet forwarded to the third node. In an embodiment, the data is forwarded to the distributed unit of the third node (such as from the distributed unit of the second node to the distributed unit of the third node)

In an embodiment, when the user equipment is in dual connectivity, the above data may be MN-terminated SCG bearer, and/or MN-terminated split bearer, and/or SN-terminated SCG bearer, and/or SN-terminated split bearer.

Step 1-1-2: The third node transmits a second message to the first node. The second message may be a first configuration response message, which is used to provide configuration information on the third node side, and which may help the first node to configure the user equipment on one hand, and help the first node to forward data on the other hand, or help the first node to inform the second node of information related to data forwarding. The message may include at least one of the following information:

First transmission response information, which is used to indicate whether the third node has accepted the request from the first node (such as “accepted” or “not accepted”), which may be the first transmission request information in the above step 1-1-1. In an embodiment, when the user equipment is in dual connectivity, the data targeted by the above-mentioned “first transmission response information” may be MN-terminated SCG bearer, and/or MN-terminated split bearer, and/or SN-terminated SCG bearer, and/or SN-terminated split bearer

First user configuration information, which includes the configuration information generated by the third node for data transmission required by the user equipment, and in an embodiment, this information may be transmitted by the first node to the user equipment. The information may include at least one of the following information:

Radio Bearer Identification Information, such as DRB ID

The first transmission configuration indication information, which is used to indicate the configuration for data transmission performed by the user equipment in the serving node change procedure, and the data is the radio bearer indicated by the abovementioned “radio bearer identification information”. In an embodiment, the indication information indicates that the user equipment still maintains data transmission (such as receiving or transmitting data) with other nodes (such as the first node and/or the second node) during the access procedure to the third node by the user equipment

Second configuration information related to user data, which is used to provide configuration information related to user data transmission generated by the third node. This information may help the first node to generate configuration for user equipment transmission, and may also inform the first node of configuration information used when the third node receives the forwarded data. The information may include at least one of the following information:

Data identification information, which identifies the data of the user equipment, with the data being the data that needs to be served by the third node after the user equipment accesses the third node; in an embodiment, if the data is a PDU session of the user equipment, the identification information is an identification of the PDU session; in another embodiment, if the data is a QoS flow of the user equipment, the identification information is an identification of the QoS flow; in another embodiment, if the data is a radio bearer of the user equipment (such as a Data Radio Bearer (DRB)), the identification information is an identification of the RB

First data transmission response information, which is used to inform the first node whether the third node has accepted the request from the first node (such as “accepted” or “not accepted”), which may be the “first data transmission request information” in the above step 1-1-1. In an embodiment, when the user equipment is in dual connectivity, the data targeted by the above-mentioned “first data transmission response information” may be MN-terminated SCG bearer, and/or MN-terminated split bearer, and/or SN-terminated SCG bearer, and/or SN-terminated split bearer

First data forwarding response indication information, which is used to indicate the configuration information for receiving the forwarded data at the third node, and the forwarded data may be the data indicated by the above-mentioned “data identification information”. The information may include at least one of the following information:

First configuration information for forwarding the user downlink data, which is used to indicate the configuration information used when receiving the forwarded downlink data at the third node, and the information includes at least one of the transport layer address and the identification information of the tunnel endpoint

First configuration information for forwarding the user uplink data, which is used to indicate the configuration information used when receiving the forwarded uplink data at the third node, and the information includes at least one of the transport layer address and the identification information of the tunnel endpoint

First response information for inter-DU user data forwarding, which is used to indicate the configuration information used when receiving the forwarded data at the distributed unit of the third node, and the information includes at least one of the transport layer address and the identification information of the tunnel endpoint

First response information for inter-DU uplink user data forwarding, which is used to indicate the configuration information used when receiving the forwarded uplink data at the distributed unit of the third node, and the information includes at least one of the transport layer address and the identification information of the tunnel endpoint

First response information for inter-DU downlink user data forwarding, which is used to indicate the configuration information used when receiving the forwarded downlink data at the distributed unit of the third node, and the information includes at least one of the transport layer address and the identification information of the tunnel endpoint

In an embodiment, when the user equipment is in dual connectivity, the above data may be MN-terminated SCG bearer, and/or MN-terminated split bearer, and/or SN-terminated SCG bearer, and/or SN-terminated split bearer.

Further, optionally, step 1-1-3 is included after step 1-1-2, that is, the third node transmits a third message to the first node. The third message may be a first configuration confirmation message, which is used to indicate that the user equipment has accessed the third node. In an embodiment, when the user equipment is in dual connectivity, the message may indicate that the secondary node change is successful, for example, the message may be a SN change success message, which may contain identification information of the user equipment. After receiving the message, the first node may initiate the procedure of releasing the second node.

In the above process, the first configuration request message may be an S-NODE ADDITION REQUEST message, and the first configuration response message may be an S-NODE ADDITION REQUEST ACKNOWLEDGE message, or may be other messages (such as other XnAP message, X2AP message, etc.).

The above process has the beneficial effects that the first node may add a new node (e.g., the third node) serving the user equipment, and the user equipment may be configured to not only maintain data transmission with the source node, but also perform the access procedure with the target node, during the node change procedure, and configuration for data forwarding may also be performed. Therefore, the application can avoid the interruption of user data transmission during the node change procedure, ensure the continuity of user data transmission, thereby improving the throughput of user equipment.
2) Process 2: the process between the first node and the second node

When adding a new node (such as the third node) for the user equipment, in addition to the configuration between the first node and the third node, a configuration process between the first node and the second node is also required, which may be used to configure the second node to still perform data transmission (including receiving and/or transmitting data) with the user equipment during the access to the third node by the user equipment.

FIG. 8 is another example process between nodes that may be involved in the mechanism of node change in a multi-connectivity scenario according to an example embodiment of the present disclosure. As shown in FIG. 8, the process may include the following steps:

Step 1-2-1: The first node transmits a fourth message to the second node. The fourth message may be a second configuration request message, and the second node is a node to which the user equipment is connected, and the message is used to configure the second node for data transmission with the user equipment during the node change procedure for the user equipment. The message may include at least one of the following information:

Indication information of data transmission behaviour, which indicates the transmission mode of user data. The information may include at least one of the following information:

Indication information of data whose transmission is to be stopped, which indicates data whose transmission is to be stopped by the second node. In an embodiment, if the “data whose transmission is to be stopped” is data of PDU session, the indication information contains identification information of one or more PDU sessions; in an embodiment, if the “data whose transmission is to be stopped” is data of QoS flow, the indication information contains identification information of one or more QoS flows; and in another embodiment, if the “data whose transmission is to be stopped” is data of radio bearer, the indication information contains identification information of one or more radio bearers

Indication information of data that continues to be transmitted (whose transmission is not to be stopped), which indicates the data whose transmission is not to be stopped by the second node. In an embodiment, if the “data whose transmission is not to be stopped” is data of PDU session, the indication information contains identification information of one or more PDU sessions, in an embodiment, if the “data whose transmission is not to be stopped” is data of QoS flow, the indication information contains identification information of one or more QoS flows, and in another embodiment, if the “data whose transmission is not to be stopped” is data of radio bearer, the indication information contains identification information of one or more radio bearers

Indication information of released data, which indicates the data released by the second node. In an embodiment, if the “released data” is data of PDU session, the indication information contains identification information of one or more PDU sessions; in an embodiment, if the “released data” is data of QoS flow, the indication information contains identification information of one or more QoS flows; and in another embodiment, if the “released data” is data of radio bearer, the indication information contains identification information of one or more radio bearers

Indication information of unreleased data, which indicates the data not released by the second node. In an embodiment, if the “unreleased data” is data of PDU session, the indication information contains identification information of one or more PDU sessions; in an embodiment, if the “unreleased data” is data of QoS flows, the indication information contains identification information of one or more QoS flows; in another embodiment, if the “unreleased data” is data of radio bearer, the indication information contains identification information of one or more radio bearers

Third configuration information related to the user data, which is used to configure the transmission of the user data. The information may include at least one of the following information:

Data identification information, which identifies the data of the user equipment, with the data being the one served by the second node; in an embodiment, if the data is a PDU session of the user equipment, the identification information is an identification of the PDU session; in another embodiment, if the data is a QoS flow of the user equipment, the identification information is an identification of the QoS flow; in another embodiment, if the data is a radio bearer of the user equipment (such as a Data Radio Bearer (DRB)), the identification information is an identification of the RB

Indication information of node change type, which is used to indicate the node change type for the data identified by the above-mentioned “data identification information”, and in an embodiment, the node change type indicated by this information is that in the procedure that the node serving the user equipment changes from the second node to other nodes (such as the third node), the user equipment still maintains data transmission with the second node while accessing other nodes (such as the third node)

Second transmission configuration information, which is used to configure the data transmission performed by the user equipment in the serving node change procedure, and the data is the data indicated by the above-mentioned “data identification information”. In an embodiment, the indication information indicates that the second node still maintains the transmission of the data indicated by the above-mentioned “data identification information”, and in another embodiment, the indication information indicates that the second node stops the transmission of the data indicated by the above-mentioned “data identification information”

First data forwarding configuration information, which is used to configure the second node to forward data, and in an embodiment, the data is forwarded to the third node. The forwarded data may be the data indicated by the above-mentioned “data identification information”. The information may include at least one of the following information:

Configuration information of downlink data forwarding, which is used to indicate the configuration information used by the second node when forwarding downlink data. The information includes at least one of the transport layer address and the identification information of the tunnel endpoint at the node (such as the third node) receiving the forwarded data

Configuration information of uplink data forwarding, which is used to indicate the configuration information used by the second node when forwarding uplink data. The information includes at least one of the transport layer address and the identification information of the tunnel endpoint at the node (such as the third node) receiving the forwarded data

Enabling information of inter-DU data forwarding, which is used to indicate the second node to forward data between distributed units. In an embodiment, the information indicates the second node to forward data to distributed units of other nodes (such as the third node). In an embodiment, the information indicates the second node to configure its distributed unit (that is, the distributed unit of the second node) to forward data to other nodes (such as the third node). In another embodiment, the information indicates the second node to configure its distributed unit (that is, the distributed unit of the second node) to forward data to the distributed units of other nodes (such as the third node)

Configuration information of inter-DU data forwarding, which is used to indicate the configuration information used by the second node (or the distributed unit of the second node) when forwarding data. The information includes at least one of the transport layer address and the identification information of the tunnel endpoint at the node (such as the third node or the distributed unit of the third node) receiving the forwarded data

Configuration information of inter-DU uplink data forwarding, which is used to indicate the configuration information used by the second node (or the distributed unit of the second node) when forwarding uplink data. The information includes at least one of the transport layer address and the identification information of the tunnel endpoint at the node (such as the third node or the distributed unit of the third node) receiving the forwarded data

Configuration information of inter-DU downlink data forwarding, which is used to indicate the configuration information used by the second node (or the distributed unit of the second node) when forwarding downlink data. The information includes at least one of the transport layer address and the identification information of the tunnel endpoint at the node (such as the third node or the distributed unit of the third node) receiving the forwarded data

In an embodiment, when the user equipment is in dual connectivity, the above data may be MN-terminated SCG bearer, and/or MN-terminated split bearer, and/or SN-terminated SCG bearer, and/or SN-terminated split bearer.

Step 1-2-2: The second node transmits a fifth message to the first node. The fifth message may be a second configuration response message, which is used to provide configuration information related to user data transmission at the second node. The message may include at least one of the following information:

Fourth configuration information related to the user data, which is used to configure the transmission of the user data. The information may include at least one of the following information:

Data identification information, which identifies the data of the user equipment, with the data being served by the second node; in an embodiment, if the data is a PDU session of the user equipment, the identification information is an identification of the PDU session; in another embodiment, if the data is a QoS flow of the user equipment, the identification information is an identification of the QoS flow; in another embodiment, if the data is a radio bearer of the user equipment (such as a Data Radio Bearer (DRB)), the identification information is an identification of the RB

Maximum identification information of forwarded data, which indicates the maximum sequence number of data packets forwarded by the second node (or the distributed unit of the second node) to other nodes (such as the third node or the distributed unit of the third node)

Maximum identification information of forwarded downlink data, which indicates the maximum sequence number of the downlink data packet forwarded by the second node (or the distributed unit of the second node) to other nodes (such as the third node or the distributed unit of the third node)

Maximum identification information of forwarded uplink data, which indicates the maximum sequence number of the uplink data packet forwarded by the second node (or the distributed unit of the second node) to other nodes (such as the third node or the distributed unit of the third node)

In the above process, the second configuration request message may be an S-NODE MODIFICATION REQUEST message, and the second configuration response message may be an S-NODE MODIFICATION REQUEST ACKNOWLEDGE message, or may be other messages (such as other XnAP message, X2AP message, etc.).

The above process has the beneficial effect that the first node may configure the second node to perform transmission of the user data, which occurs in the procedure that the node serving the user equipment changes from the second node to other nodes (such as the third node). Through the above configuration process, it may be realized that the user equipment still maintains data transmission with the source node in the procedure of accessing the new node, thus reducing the interruption of data transmission in the node change procedure and keeping the continuity of data transmission. In addition, the above process may realize that the distributed unit of the second node forwards data to the distributed unit of the third node, thereby reducing the time delay of data forwarding.

In addition, when the second node and the third node are the source master node and the target master node respectively, the interaction between the second node and the third node may also be included.

FIG. 9 is another example process between nodes that may be involved in the mechanism of node change in a multi-connectivity scenario according to an example embodiment of the present disclosure. As shown in FIG. 9, the process may include the following steps:

Step 1-3-1: The second node transmits a first configuration request message to the third node, and the contents contained in the message may be referred to the first configuration request message in the above step 1-1-1;

Step 1-3-2: The third node transmits a first configuration response message to the second node, and the contents contained in the message may be referred to the first configuration response message in the above step 1-1-2.

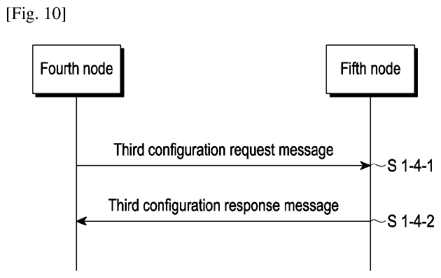

In addition, when the second node and the third node are two different base stations, if the second node/third node includes a central unit and a distributed unit, the interaction process between the central unit and the distributed unit is also included, as shown in FIG. 10.

FIG. 10 is another example process between nodes that may be involved in the mechanism of node change in a multi-connectivity scenario according to an example embodiment of the present disclosure. This process involves two nodes, namely:

Fourth node: the central unit of the base station, or the control plane portion of the central unit of the base station, the base station may be the above-mentioned second node or the above-mentioned third node

Fifth node: the distributed unit of the base station, the base station may be the abovementioned second node or the above-mentioned third node

In an embodiment, as shown in FIG. 10, the example process may include the following steps:

Step 1-4-1: The fourth node transmits a sixth message to the fifth node. The sixth message may be a third configuration request message, which is used to request for information and/or configuration related to data transmission (including, for example, forwarding), or to configure transmission of data, and the message may include at least one of the following information:

Indication information of first forwarding request, which is used to request the fifth node to provide information related to user data transmission (including, for example, forwarding). The information may include at least one of the following information:

Forwarding indication information, which is used to indicate the type of data forwarding, such as indication information of inter-DU data forwarding (which is used to indicate that data forwarding occurs between distributed units or other nodes will forward data to the fifth node), indication information of inter-DU downlink data forwarding (which is used to indicate that downlink data forwarding occurs between distributed units or other nodes will forward downlink data to the fifth node), indication information of inter-DU uplink data forwarding (which is used to indicate that uplink data forwarding occurs between distributed units, or other nodes will forward uplink data to the fifth node)

Indication information of forwarded data, which is used to indicate the forwarded data, and according to which the fifth node may provide information related to data forwarding. The information may include at least one of the following information:

Identification information of session, such as identification information of a PDU session

Identification information of QoS flow, such as a QoS Flow ID

Identification information of radio bearer, such as a RB ID

Indication information of first forwarding configuration, which is used to configure the forwarding of user data. The information may include at least one of the following information:

Data identification information, which identifies the data of the user equipment, with the data being the data served by the fifth node; in an embodiment, if the data is a PDU session of the user equipment, the identification information is an identification of the PDU session; in another embodiment, if the data is a QoS flow of the user equipment, the identification information is an identification of the QoS flow; in another embodiment, if the data is a radio bearer of the user equipment (such as a Data Radio Bearer (DRB)), the identification information is an identification of the RB

Enabling information of inter-DU data forwarding, which is used to indicate the fifth node to perform data forwarding between distributed units. In an embodiment, the information indicates the fifth node to forward data to other nodes or distributed units of other nodes

Configuration information of data forwarding, which is used to indicate the configuration information used by the fifth node when forwarding data. The information includes at least one of the transport layer address and the identification information of the tunnel endpoint at the node receiving the forwarded data

Configuration information of downlink data forwarding, which is used to indicate the configuration information used by the fifth node when forwarding downlink data. The information includes at least one of the transport layer address and the identification information of the tunnel endpoint at the node receiving the forwarded data

Configuration information of uplink data forwarding, which is used to indicate the configuration information used by the fifth node when forwarding uplink data. The information includes at least one of the transport layer address and the identification information of the tunnel endpoint at the node receiving the forwarded data

Maximum identification information of forwarded data, which indicates the maximum sequence number of the data packet forwarded to the fifth node

Maximum identification information of forwarded downlink data, which indicates the maximum sequence number of the downlink data packet forwarded to the fifth node

Maximum identification information of forwarded uplink data, which indicates the maximum sequence number of the uplink data packet forwarded to the fifth node

In an embodiment, when the user equipment is in dual connectivity, the above data may be MN-terminated SCG bearer, and/or MN-terminated split bearer, and/or SN-terminated SCG bearer, and/or SN-terminated split bearer.

Step 1-4-2: The fifth node transmits a seventh message to the fourth node. The seventh message may be a third configuration response message, which is used to provide information related to data transmission (including, for example, information related to receiving the forwarded data), or information related to transmitted (including, for example, forwarded) data. The message may include at least one of the following information:

Indication information of first forwarding response, which is used to provide the fourth node with information related to receiving the forwarded data. The information may include at least one of the following information:

Data identification information, which identifies the data of the user equipment, with the data being the data received by the fifth node; in an embodiment, if the data is a PDU session of the user equipment, the identification information is an identification of the PDU session; in another embodiment, if the data is a QoS flow of the user equipment, the identification information is an identification of the QoS flow; In another embodiment, if the data is a radio bearer of the user equipment (such as a Data Radio Bearer (DRB)), the identification information is an identification of the RB

Enabling information of inter-DU data forwarding, which is used to indicate the fifth node to receive the forwarded data. In an embodiment, the information indicates the fifth node to receive the data forwarded by other nodes or distributed units of other nodes

Configuration information of data forwarding, which is used to indicate the configuration information used by the fifth node when receiving the data. The information includes at least one of the transport layer address and the identification information of the tunnel endpoint at the fifth node

Configuration information of downlink data forwarding, which is used to indicate the configuration information used by the fifth node when receiving the downlink data. The information includes at least one of the transport layer address and the identification information of the tunnel endpoint at the fifth node

Configuration information of uplink data forwarding, which is used to indicate the configuration information used by the fifth node when receiving the uplink data. The information includes at least one of the transport layer address and the identification information of the tunnel endpoint at the fifth node

Configuration information of forwarded data, which is used to indicate information related to the data forwarded by the fifth node (including, for example, the configuration of the data forwarded by the fifth node). The information may include at least one of the following information:

Data identification information, which identifies the data of the user equipment, with the data being the data forwarded by the fifth node; in an embodiment, if the data is a PDU session of the user equipment, the identification information is an identification of the PDU session; in another embodiment, if the data is a QoS flow of the user equipment, the identification information is an identification of the QoS flow; in another embodiment, if the data is a radio bearer of the user equipment (such as a Data Radio Bearer (DRB)), the identification information is an identification of the RB

Maximum sequence number of the forwarded data, such as a PDCP sequence number (PDCP SN)

Maximum sequence number of the forwarded downlink data, such as a PDCP sequence number (PDCP SN)

Maximum sequence number of the forwarded uplink data, such as a PDCP sequence number (PDCP SN)

In the above process, the third configuration request message may be a UE CONTEXT SETUP/MODIFICATION REQUEST message, and the third configuration response message may be a UE CONTEXT SETUP/MODIFICATION RESPONSE message, or they may be other messages (such as other F1AP messages, etc.).

The above process has the beneficial effects of obtaining or configuring information required by user data forwarding, and realizing data forwarding among distributed units of different nodes.

According to the difference of base stations where the fourth node and the fifth node are located, the above process includes the following possible embodiments:

Implementation 1-4a: (which occurs in the second node and obtains the information of forwarded data)

Step 1-4a-1: The fourth node transmits a third configuration request message to the fifth node, which may include the following information:

Indication information of first forwarding request

Step 1-4a-2: The fifth node transmits a third configuration response message to the fourth node, which may include the following information:

Configuration information of forwarded data

In this implementation, the central unit (or the control plane portion of the central unit) of the second node requests the distributed unit of the second node to provide “configuration information related to the forwarded data”, such as the maximum sequence number of the forwarded data, the maximum sequence number of the forwarded downlink data, and the maximum sequence number of the forwarded uplink data. The central unit (or the control plane portion of the central unit) of the second node may transmit “configuration information related to the forwarded data” to the third node, so that the third node may learn which forwarded data it will receive.

Implementation 1-4b: (which occurs in the second node and provides configuration information of forwarded data to the distributed unit)

Step 1-4b-1: The fourth node transmits a third configuration request message to the fifth node, the message may include at least one of the following information:

Indication Information of First Forwarding Request

Indication Information of First Forwarding Configuration

Step 1-4b-2: The fifth node transmits a third configuration response message to the fourth node, the message may be an acknowledgement of the third configuration request message received in the above step 1-4b-1. Further, the message may also include the following information:

Configuration Information of Forwarded Data

In this implementation, the central unit (or the control plane portion of the central unit) of the second node may provide the distributed unit of the second node with configuration information of forwarded data, such as address information of the receiving node side for the data forwarded by the distributed unit of the second node, which may be obtained by the central unit (or the control plane portion of the central unit) of the second node from other nodes (such as the third node).

Implementation 1-4c: (which occurs in the third node, and obtains the configuration information for receiving the forwarded data at the distributed unit)

Step 1-4c-1: The fourth node transmits a third configuration request message to the fifth node, the message may include at least one of the following information:

Indication Information of First Forwarding Request

Indication Information of First Forwarding Configuration

Step 1-4c-2: The fifth node transmits a third configuration response message to the fourth node, the message may also include the following information:

Indication information of first forwarding response

In this Implementation, the central unit (or the control plane portion of the central unit) of the third node may provide the distributed unit of the third node with configuration information of forwarded data, such as the maximum sequence number of the forwarded data, the maximum sequence number of the forwarded downlink data, or the maximum sequence number of the forwarded uplink data, the distribution unit of the third node provides the central unit (or the control plane portion of the central unit) of the third node with the address information for receiving the forwarded data, and the information will be transmitted to other nodes for forwarding the data by the other nodes to the distributed unit of the third node.

The above multiple processes may also be combined with each other. When the second node and the third node do not include the central unit and the distributed unit, the process after the above processes are combined is as follows.

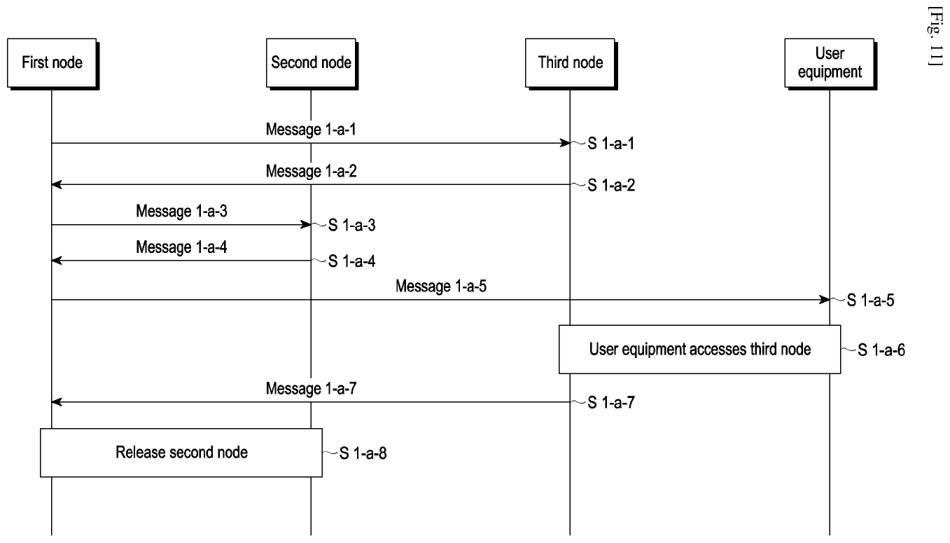

FIG. 11 is another example process between nodes and a user equipment that may be involved in the mechanism of node change in a multi-connectivity scenario according to an example embodiment of the present disclosure. As shown in FIG. 11, the process may include the following steps:

Step 1-a-1: The first node transmits a message 1-a-1 to the third node, and the information contained in the message may be referred to the above step 1-1-1

Step 1-a-2: The third node transmits a message 1-a-2 to the first node, and the information contained in the message may be referred to the above step 1-1-2

Step 1-a-3: The first node transmits a message 1-a-3 to the second node, and the contents of the message may be referred to the above step 1-2-1

Step 1-a-4: The second node transmits a message 1-a-4 to the first node, and the contents of the message may be referred to the above step 1-2-2

Step 1-a-5: The first node transmits a message 1-a-5 to the user equipment, and the message may include a user configuration message for configuring the user equipment to change the serving node. In this message, the transmission configuration of user data will be indicated. In an implementation, the transmission configuration indicates the data that may continue to be transmitted with the second node in the procedure of accessing the third node by the user equipment. To indicate these data, the message may include at least one of identification information of a PDU session, identification information of a QoS flow and identification information of a radio bearer; specifically, the data indicated by the above identification information is the data that may continue to be transmitted with the second node in the procedure of accessing the third node by the user equipment

Step 1-a-6: The user equipment accesses the third node, for example, the user equipment performs the random access procedure to the third node

Step 1-a-7: After the user equipment successfully accesses the third node, the third node transmits a message 1-a-7 to the first node, and the information in the message may be referred to the above step 1-1-3

Step 1-a-8: The first node performs signaling interaction with the second node, and the signaling interaction procedure is used to release configuration information related to the user equipment at the second node

When the second node and the third node each include a central unit and a distributed unit, the process after the above processes are combined is as follows.

FIG. 12 is another example process between nodes and a user equipment that may be involved in the mechanism of node change in a multi-connectivity scenario according to an example embodiment of the present disclosure. As shown in FIG. 12, the process may include the following steps:

Step 1-b-1: The first node transmits a message 1-b-1 to the central unit (or the control plane portion of the central unit) of the third node, and the information contained in the message may be referred to the above step 1-1-1

Step 1-b-2: The central unit (or the control plane portion of the central unit) of the third node transmits a message 1-b-2 to the distributed unit of the third node, and the information contained in the message may be referred to the above step 1-4c-1

step 1-b-3: The distributed unit of the third node transmits a message 1-b-3 to the central unit (or the control plane portion of the central unit) of the third node. The information contained in the message may be referred to the above step 1-4c-2

Step 1-b-4: The central unit (or the control plane portion of the central unit) of the third node transmits a message 1-b-4 to the first node, and the information contained in the message may be referred to the above step 1-1-2

Step 1-b-5: The first node transmits a message 1-b-5 to the central unit (or the control plane portion of the central unit) of the second node. The contents contained in the message may be referred to the above step 1-2-1

Step 1-b-6: The central unit (or the control plane portion of the central unit) of the second node transmits a message 1-b-6 to the distributed unit of the second node. The contents contained in the message may be referred to the above step 1-4b-1

Step 1-b-7: The distributed unit of the second node transmits a message 1-b-7 to the central unit (or the control plane portion of the central unit) of the second node. The contents contained in the message may be referred to the above step 1-4b-2

Step 1-b-8: The central unit (or the control plane portion of the central unit) of the second node transmits a message 1-b-8 to the first node, and the contents contained in the message may be referred to the above step 1-2-2

Step 1-b-9: The first node transmits a message 1-b-9 to the user equipment. The content contained in the message may be a user equipment configuration message, which is used to configure the user equipment to change the serving node. In this message, the first node will indicate the transmission configuration of user data. In an implementation, the transmission configuration indicates the data that may continue to be transmitted with the second node in the procedure of accessing the third node by the user equipment. To indicate these data, the message may include at least one of identification information of a PDU session, identification information of a QoS flow and identification information of a radio bearer; specifically, the data indicated by the above identification information is the data that may continue to be transmitted with the second node in the procedure of accessing the third node by the user equipment

Step 1-b-10: The user equipment accesses the third node, for example, the user equipment performs the random access procedure to the third node

Step 1-b-11: After the user equipment successfully accesses the third node, the central unit (or the control plane portion of the central unit) of the third node transmits a message 1-b-11 to the first node, and the contents contained in the message may be referred to the above step 1-1-3

Step 1-b-12: The first node performs signaling interaction with the second node, the interaction procedure is used to release configuration information related to the user equipment at the second node

Second Aspect: A Method of Dynamic Change of Serving Nodes in Multi-Connectivity Scenario

The scenario considered in this aspect is that a user equipment may perform data transmission with a plurality of nodes (any node of the plurality of nodes may be a base station or a distributed unit of the base station), and the nodes that perform data transmission with the user equipment may be dynamically changed.

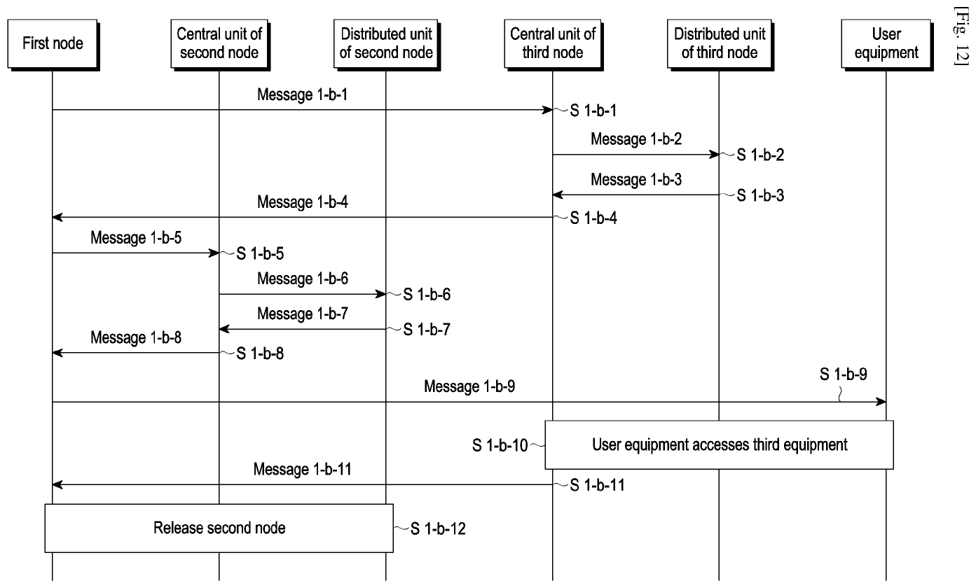

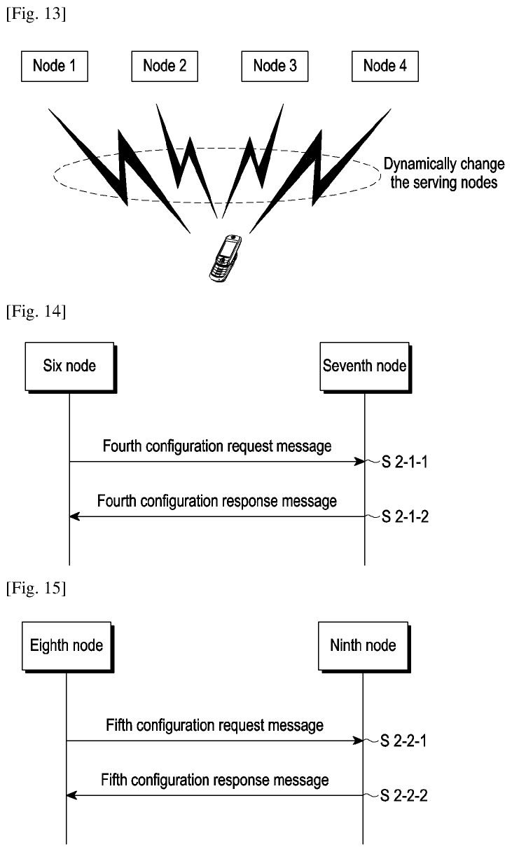

For example, FIG. 13 is a schematic diagram of dynamic change of a serving node in a multi-connectivity scenario according to an example embodiment of the present disclosure.

As shown in FIG. 13, the user equipment may perform data transmission with nodes 1/2/3/4, etc., and at any time, the network side may dynamically select one or more nodes to perform data transmission with the user equipment. In order to realize the dynamic change of the nodes serving the user equipment, this aspect includes the following processes:
1) Process 1: configuration process of nodes serving user equipment

This process is used to configure one or more nodes serving the user equipment. The nodes involved in this process include:
Sixth node: This node may be a base station serving the user equipment, or a central unit of the base station, or a control plane portion of the central unit of the base station.
Seventh node: this node may be a base station serving the user equipment, or a central unit of the base station, or a control plane portion of the central unit of the base station, or a user plane portion of the central unit of the base station, or a distributed unit of the base station.

In an implementation, when the user equipment is served by two or more base stations, the sixth node is the first base station serving the user equipment (or a central unit of the first base station, or a control plane portion of the central unit of the first base station), while the seventh node is one of other base stations serving the user equipment, which is different from the sixth node (or a central unit of the base station, or a control plane portion of the central unit of the base station, or a user plane portion of the central unit of the base station, or a distributed unit of the base station). In another embodiment, when the user equipment is served by two or more distributed units, the sixth node is the central unit to which these distributed units are connected, or a control plane portion of the central unit, and the seventh node is one of these distributed units.

FIG. 14 is an example process between nodes that may be involved in a method for dynamically changing serving nodes in a multi-connectivity scenario according to an example embodiment of the present disclosure. As shown in FIG. 14, the process may include the following steps:

Step 2-1-1: The sixth node transmits an eighth message to the seventh node. The eighth message may be a fourth configuration request message, and its functions include 1) requesting to acquire configuration information for serving the user equipment at the seventh node, and 2) providing configuration information of other nodes serving the user equipment to the seventh node. The message may include at least one of the following information:

Indication information of acquiring configuration information, which is used to request the seventh node to provide configuration information related to data transmission. The information may include at least one of the following information:

First request information, which is used to request the seventh node to provide configuration information for transmitting data (such as configuration information of a tunnel required for receiving data) that may come from other nodes (such as other base stations, or central units of other base stations, or user plane portions of central units of other base stations, or other distributed units)

First enabling information, which is used to inform the seventh node whether other nodes (such as other base stations, or central units of other base stations, or user plane portions of central units of other base stations, or other distributed units) are enabled to transmit data to the seventh node. If “enabled”, the seventh node needs to provide configuration information for receiving data; if “not enabled”, the seventh node does not need to provide configuration information for receiving data

Data identification information, which identifies the data of the user equipment, with the data being the data served by the seventh node. In an embodiment, if the data is a PDU session of the user equipment, the identification information is an identification of the PDU session; in another embodiment, if the data is a QoS flow of the user equipment, the identification information is an identification of the QoS flow; in another embodiment, if the data is a radio bearer (such as a Data Radio Bearer (DRB)) of the user equipment, the identification information is an identification of the RB. Further, the information may further implicitly indicate that the seventh node is requested to provide configuration information related to data transmission, or enable other nodes to transmit data to the seventh node. In an embodiment, the “data identification information” may also be used to indicate that the seventh node is required to provide configuration information (such as configuration information of a tunnel required for receiving the data) for transmitting the data (i.e., the data identified by the “data identification information”); in another embodiment, the “data identification information” may also be used to enable other nodes (such as other base stations, or central units of other base stations, or user plane portions of central units of other base stations, or other distributed units) to transmit the data (i.e., the data identified by the “data identification information”) to the seventh node; in another embodiment, the “data identification information” may be combined with the above-mentioned “first request information” to indicate that the seventh node is required to provide configuration information (such as configuration information of a tunnel required for receiving data) for transmitting the data (i.e., data identified by the “data identification information”); and in another embodiment, the “data identification information” may be combined with the above-mentioned “first enabling information” to enable other nodes (such as other base stations, or central units of other base stations, or user plane portions of central units of other base stations, or other distributed units) to transmit the data (i.e., the data identified by the “data identification information”) to the seventh node

Identification information of a cell group, such as a master cell group, a secondary cell group, cell group 1, cell group 2, etc. Further, the information may further implicitly indicate that the seventh node is requested to provide configuration information related to data transmission, or enable other nodes to transmit data to the seventh node. In an embodiment, the “identification information of a cell group” may also be used to indicate that the seventh node is required to provide configuration information (such as configuration information of a tunnel required for receiving data) for transmitting data (i.e., the data identified by the “data identification information”) from the cell group; in another embodiment, the “identification information of a cell group” may also be used to enable other nodes serving the cell group (such as other base stations, or central units of other base stations, or user plane portions of central units of other base stations, or other distributed units) to transmit the data to the seventh node; in another embodiment, the “identification information of a cell group” may be combined with the above-mentioned “first request information” to indicate that the seventh node is required to provide configuration information (such as configuration information of a tunnel required for receiving data) for transmitting data from the cell group; in another embodiment, the “identification information of a cell group” may be combined with the above-mentioned “first enabling information” to enable other nodes (such as other base stations, or central units of other base stations, or user plane portions of central units of other base stations, or other distributed units) serving the cell group to transmit data to the seventh node

Cell identification information. Further, the information may implicitly indicate that the seventh node is requested to provide configuration information related to data transmission, or enable other nodes to transmit data to the seventh node. In an embodiment, the “cell identification information” may also be used to indicate that the seventh node is required to provide configuration information (such as configuration information of a tunnel required for receiving data) for transmitting data from the cell (i.e., data identified by the “data identification information”); in another embodiment, the “cell identification information” may also be used to enable other nodes (such as other base stations, or central units of other base stations, or user plane portions of central units of other base stations, or other distributed units) serving the cell to transmit data to the seventh node; in another embodiment, the “cell identification information” may be combined with the above-mentioned “first request information” to indicate that the seventh node is required to provide configuration information (such as configuration information of a tunnel required for receiving data) for transmitting data from the cell; in another embodiment, the “cell identification information” may be combined with the above-mentioned “first enabling information” to enable other nodes (such as other base stations, or central units of other base stations, or user plane portions of central units of other base stations, or other distributed units) serving the cell to transmit data to the seventh node

Node identification information. The node identified by this information is other nodes different from the seventh node (such as other base stations, or central units of other base stations, or user plane portions of central units of other base stations, or other distributed units). In an embodiment, the information indicates that the seventh node needs to provide configuration information (such as the configuration information of a tunnel required for receiving data) to transmit the data transmitted by the node identified by the “node identification information”; in another embodiment, the information indicates other nodes (such as other base stations, or central units of other base stations, or user plane portions of central units of other base stations, or other distributed units) that transmit data to the seventh node; in another embodiment, the information may be combined with the above-mentioned “first request information” to indicate that the seventh node needs to provide configuration information (such as configuration information of a tunnel required for receiving data) to transmit the data transmitted by the node identified by the “node identification information”; and in another embodiment, the information may be combined with the above-mentioned “first enabling information” to indicate other nodes (such as other base stations, or central units of other base stations, or user plane portions of central units of other base stations, or other distributed units) that transmit data to the seventh node

First data transmission configuration information, which is used to provide the seventh node with configuration information required for data transmission. In an embodiment, the configuration information is configuration information used by the seventh node when transmitting data to other nodes (other nodes different from the seventh node, such as other base stations, or central units of other base stations, or user plane portions of central units of other base stations, or other distributed units). The information may include at least one of the following information:

Identification information of a cell group, which indicates identification information of a cell group serving data transmitted by the seventh node (in an embodiment, the cell group is served by other nodes different from the seventh node)

Cell identification information, which indicates identification information of a cell serving the data transmitted by the seventh node (in an embodiment, the cell is served by other nodes different from the seventh node)

Node identification information, which indicates a node serving the data transmitted by the seventh node (in an embodiment, this node is another node different from the seventh node)

Data identification information, which identifies the data of the user equipment, with the data being data transmitted by the seventh node. Further, the data will be served by other nodes. In an embodiment, if the data is a PDU session of the user equipment, the identification information is an identification of the PDU session; in another embodiment, if the data is a QoS flow of the user equipment, the identification information is an identification of the QoS flow; and in another embodiment, if the data is a radio bearer of the user equipment (such as a Data Radio Bearer (DRB)), the identification information is an identification of the RB

Tunnel identification information, which identifies a tunnel required for transmitting data

First configuration information of data, which indicates configuration information on other node side, is used by the seventh node for data transmission, and includes at least one of the transport layer address and the identification information of the tunnel endpoint at other nodes

First configuration information of uplink data, which indicates configuration information on other node side, is used by the seventh node for uplink data transmission, and includes at least one of the transport layer address and the identification information of the tunnel endpoint at other nodes

First configuration information of downlink data, which indicates configuration information on other node side, is used by the seventh node for downlink data transmission, and includes at least one of the transport layer address and the identification information of the tunnel endpoint at other nodes

First data configuration information, which is used to provide the seventh node with configuration information related to the transmitted data. The information may include at least one of the following information:

Data identification information, which identifies the data received by the seventh node. In an embodiment, if the data is a PDU session of the user equipment, the identification information is an identification of the PDU session; in another embodiment, if the data is a QoS flow of the user equipment, the identification information is an identification of the QoS flow; in another embodiment, if the data is a radio bearer of the user equipment (such as a Data Radio Bearer (DRB)), the identification information is an identification of the RB

Identification information of a cell group, such as a master cell group, a secondary cell group, cell group 1, cell group 2, etc., which indicates a cell group to which the data received by the seventh node belongs

Cell identification information, which indicates a cell to which the data received by the seventh node belongs

Node identification information, which indicates a node to which the data received by the seventh node belongs

Maximum sequence number of data, such as a PDCP sequence number (a PDCP SN)

Maximum sequence number of downlink data, such as a PDCP sequence number (a PDCP SN)

Maximum sequence number of uplink data, such as a PDCP sequence number (a PDCP SN)

Step 2-1-2: The seventh node transmits a ninth message to the sixth node. The ninth message may be a fourth configuration response message, which is used to provide configuration information on the seventh node side (including, for example, configuration information for serving the user equipment). The message may include at least one of the following information:

Second data transmission configuration information, which is used to indicate configuration information used by the seventh node to transmit data. In an embodiment, the configuration information is configuration information on the seventh node side used by other nodes (such as other base stations, or central units of other base stations, user plane portions of central units of other base stations, or other distributed units) when transmitting data with the seventh node. The information may include at least one of the following information:

Identification information of a cell group, which indicates a cell group to which the data transmitted by the seventh node belongs

Cell identification information, which indicates a cell to which the data transmitted by the seventh node belongs

Node identification information, which indicates a node to which the data transmitted by the seventh node belongs

Data identification information, which identifies data of the user equipment, with the data is data transmitted by the seventh node. In an embodiment, if the data is a PDU session of the user equipment, the identification information is an identification of the PDU session; in another embodiment, if the data is a QoS flow of the user equipment, the identification information is an identification of the QoS flow; and in another embodiment, if the data is a radio bearer of the user equipment (such as a Data Radio Bearer (DRB)), the identification information is an identification of the RB.

Tunnel identification information, which identifies a tunnel required for transmitting data

Second configuration information of data, which indicates configuration information on the seventh node side, and includes at least one of the transport layer address and the identification information of the tunnel endpoint at the seventh node

Second configuration information of uplink data, which indicates configuration information on the seventh node side, and includes at least one of the transport layer address and the identification information of the tunnel endpoint at the seventh node

Second configuration information of downlink data, which indicates the configuration information on the seventh node side, and includes at least one of the transport layer address and the identification information of the tunnel endpoint at the seventh node

Second data configuration information, which is used to indicate configuration information related to data transmitted by the seventh node. The information may include at least one of the following information:

Data identification information, which identifies the data transmitted by the seventh node. In an embodiment, if the data is a PDU session of the user equipment, the identification information is an identification of the PDU session; in another embodiment, if the data is a QoS flow of the user equipment, the identification information is an identification of the QoS flow; and in another embodiment, if the data is a radio bearer of the user equipment (such as a Data Radio Bearer (DRB)), the identification information is an identification of the RB

Identification information of a cell group, such as a master cell group, a secondary cell group, cell group 1, cell group 2, etc., which indicates a cell group on the seventh node side to which the data transmitted by the seventh node belongs

Cell identification information, which indicates a cell on the seventh node side to which the data transmitted by the seventh node belongs

Node identification information, which indicates a node (i.e., the seventh node) to which the data transmitted by the seventh node belongs

Maximum sequence number of data, such as a PDCP sequence number (a PDCP SN)

Maximum sequence number of downlink data, such as a PDCP sequence number (a PDCP SN)

Maximum sequence number of uplink data, such as a PDCP sequence number (a PDCP SN)

In the above process, the fourth configuration request message may be a message of an Xn/X2/F1/E1 interface, such as a S-Node Addition/Modification Request message, an SgNB Addition/Modification Request message, a UE Context Setup/Modification Request message, or a Bearer Context Setup/Modification Request message; and the fourth configuration response message may be a message of an Xn/X2/F1/E1 interface, such as a S-Node Addition/Modification Response message, an SgNB Addition/Modification Response message, a UE Context Setup/Modification Response message, or a Bearer Context Setup/Modification Response message, or they may be other messages.

The above process has the beneficial effect that the seventh node may acquire configuration information on other node side required for data transmission, and may also provide configuration information used by the seventh node side when transmitting data, thereby realizing the transmission of user data between the seventh node and other nodes. In this way, by directly interacting configuration information on the side of nodes serving the user equipment required for data transmission between nodes, the signaling overhead in the procedure of change and/or handover of the node serving the user equipment can be reduced.

According to the different types of the sixth node and the seventh node, the above process may be implemented as the following implementations:

Implementation 1: (an Interaction Process Occurs Between Different Base Stations)

In this implementation, the user equipment is served by two or more base stations, and the interaction process occurs between different base stations (or central units of base stations) serving the user equipment, such as a base station 1, a base station 2, a base station 3, and so on. Specifically, taking the interaction process between the base station 1 and base station 2 as an example, the process may include the following steps:

Step 2-1-a1: The sixth node (i.e., the base station 1, or a central unit of the base station 1, or a control plane portion of the central unit of the base station 1) transmits a fourth configuration request message to the seventh node (i.e., the base station 2, or a central unit of the base station 2, or a control plane portion of the central unit of the base station 2), the message may include at least one of the following information:

Indication information of acquiring configuration information.

First data transmission configuration information, which may respectively contain configuration information on the side of one or more nodes which may be other base stations different from the base station 2 (such as the base station 1, or a central unit of the base station 1, or a control plane portion of the central unit of the base station 1, or a user plane portion of the central unit of the base station 1, or a distributed unit of the base station 1, and/or a base station 3, or a central unit of the base station 3, or a control plane portion of the central unit of the base station 3, or a user plane portion of the central unit of the base station 3, or a distributed unit of the base station 3), etc. The configuration information may include at least one item of “first data transmission configuration information” in the above step 2-1-1

First data configuration information

Step 2-1-a2: The seventh node transmits a fourth configuration response message to the sixth node, the message may include at least one of the following information:

Second data transmission configuration information, which is configuration information on the side of the base station 2 (or a central unit of the base station 2, or a control plane portion of the central unit of the base station 2, or a user plane portion of the central unit of the base station 2, or a distributed unit of the base station 2)

Second data configuration information

This process may configure other base stations to transmit data to the base station 2, or may also configure the base station 2 to transmit data to other base stations.

Implementation 2: (an interaction process occurs between a central unit and a distributed unit of the same base station)

In this implementation, the user equipment is served by different distributed units (such as a distributed unit 1, a distributed unit 2, etc.) of the same base station, and the interaction process occurs between a central unit and one distributed unit of the base station. Specifically, taking the interaction process between the central unit of the base station (or a control plane portion of the central unit of the base station) and the distributed unit 1 as an example, the process may include the following steps:

Step 2-1-b1: The sixth node (i.e., a central unit of the base station, or a control plane portion of the central unit of the base station) transmits a fourth configuration request message to the seventh node (i.e., a distributed unit 1), the message may include at least one of the following information:

Indication information of acquiring configuration information

First data transmission configuration information, which may respectively contain configuration information on the side of one or more distributed units which may be other distributed units different from the distributed unit 1 (such as a distributed unit 2, a distributed unit 3, etc.). The configuration information may include at least one item of “first data transmission configuration information” in the above step 2-1-1

First data configuration information

Step 2-1-b2: The seventh node transmits a fourth configuration response message to the sixth node, the message may include at least one of the following information:

Second data transmission configuration information, which is configuration information on the side of distributed unit 1

Second data configuration information

The above process may configure data transmission between different distributed units of the base station.

Implementation 3: (an interaction process occurs between a control plane portion of a central unit of the base station and a user plane portion of the central unit of the base station).

In this implementation, the central unit of the base station serving the user equipment includes a control plane portion and a user plane portion, and in order to configure the data transmission of the user plane portion, a signaling interaction is needed between the control plane portion and the user plane portion. The interaction process may include the following steps:

Step 2-1-c1: The sixth node (i.e., the control plane portion of the central unit of the base station) transmits a fourth configuration request message to the seventh node (i.e., the user plane portion of the central unit of the base station), the message may include at least one of the following information:

Indication information of acquiring configuration information

First data transmission configuration information, which may respectively contain configuration information on the side of one or more other nodes which may be other nodes different from the seventh node (such as central units of other base stations, user plane portions of the central units of other base stations, and distributed units of other base stations). The configuration information may include at least one item of “first data transmission configuration information” in the above step 2-1-1

First data configuration information

Step 2-1-c2: The seventh node transmits a fourth configuration response message to the sixth node, the message may include at least one of the following information:

Second data transmission configuration information, which is configuration information on the seventh node side (i.e., the user plane portion of the central unit of the base station)

Second data configuration information

The above process may configure the user plane portion of the central unit of the base station to perform data transmission, which may be carried out with the user plane portions of central units of other base stations (or distributed units of central units of other base stations, a user plane portion of other central unit of the same base station, or a distributed unit of the same base station).
2) Process 2: Dynamic change process of nodes serving the user equipment

After the interaction in the above process 1, a node serving the user equipment may learn configuration information required when transmitting data with other nodes. In order to dynamically change the nodes serving the user equipment, it is necessary to dynamically configure the nodes serving the user equipment. The process 2 mainly completes the configuration for dynamic change of the serving nodes. The nodes involved in the process include:
Eighth node: this node informs a ninth node of information about the nodes serving the user equipment. In an embodiment, this node may decide the nodes serving the user equipment, and in another embodiment, this node may forward configuration information for configuring the nodes serving the user equipment; this node may be a base station, may also be a central unit of the base station, may also be a control plane portion of the central unit of the base station, may also be a user plane portion of the central unit of the base station, or may also be a distributed unit of the base station
Ninth node: This node is a node different from the eighth node. In an embodiment, this node may be a node serving the user equipment, and in another embodiment, this node forwards configuration information for configuring the nodes serving the user equipment. This node may be a base station, may also be a central unit of the base station, may also be a control plane portion of the central unit of the base station, may also be a user plane portion of the central unit of the base station, or may also be a distributed unit of the base station

FIG. 15 is another example process between nodes that may be involved in the method for dynamically changing a serving node in a multi-connectivity scenario according to an example embodiment of the present disclosure. As shown in FIG. 15, the process may include the following steps:

Step 2-2-1: The eighth node transmits a tenth message to the ninth node. The tenth message may be a fifth configuration request message, which is used to transmit configuration information related to the node(s) serving the user equipment, so that the ninth node may operate according to the received configuration information, and the information may include at least one of the following information:

User data indication information, which indicates the served user data. In an embodiment, if the data is a PDU session of the user equipment, the indication information is an indication of the PDU session; in another embodiment, if the data is a QoS flow of the user equipment, the indication information is an indication of the QoS flow; and in another embodiment, if the data is a radio bearer of the user equipment (such as a Data Radio Bearer (DRB)), the indication information is an indication of the RB

Indication information of serving user equipment, which is used to indicate the ninth node to serve the user equipment

Indication information of not serving the user equipment, which is used to indicate that the ninth node does not serve the user equipment

Indication information of activating a node, which is used to indicate that the ninth node is activated to serve the user equipment

Indication information of deactivating a node, which is used to indicate that the ninth node is deactivated to terminate serving the user equipment

Indication information of activating a cell group, which is used to indicate that the cell group served by the ninth node is activated

Indicating information of deactivating a cell group, which is used to indicate that the cell group served by the ninth node is deactivated

Indication information of activating a cell, which is used to indicate that the cell served by the ninth node is activated

Indication information of deactivating a cell, which is used to indicate that the cell served by the ninth node is deactivated

Indication information of node serving the user equipment, which indicates one or more nodes serving the user equipment. Further, if a node serves the user equipment, it means that the node is an activated node for the user equipment. The information may include at least one of the following information:

Identification information of a node serving the user equipment, which includes identification information of one or more nodes, the node may be a base station, or a distributed unit of the base station, or a central unit of the base station, or a control plane portion of the central unit of the base station, or a user plane portion of the central unit of the base station

Identification information of a node that do not serve the user equipment, which includes identification information of one or more nodes, the node may be a base station, or a distributed unit of the base station, or a central unit of the base station, or a control plane portion of the central unit of the base station, or a user plane portion of the central unit of the base station

Node indication information, which may be a bitmap where each bit represents a node, and a value of the bit represents whether the corresponding node serves the user equipment

Indication information of a cell group serving the user equipment, which indicates one or more cell groups serving the user equipment. Further, if a cell group serves the user equipment, it means that the cell group is an activated cell group for the user equipment. The information may include at least one of the following information:

Identification information of a cell group serving the user equipment, which includes identification information of one or more cell groups serving user equipment

Identification information of a cell group that do not serve the user equipment, which includes identification information of one or more cell groups that do not serve the user equipment

Cell group indication information, which may be a bitmap where each bit represents a cell group, and a value of the bit represents whether the corresponding cell group serves the user equipment

Indication information of a cell serving the user equipment, which indicates one or more cells serving the user equipment. Further, if a cell serves the user equipment, it means that the cell is an activated cell for the user equipment. The information may include at least one of the following information:

Identification information of a cell serving the user equipment, which includes identification information of one or more cells serving the user equipment

Identification information of a cell that do not serve the user equipment, which includes identification information of one or more cells that do not serve the user equipment

Cell indication information, which may be a bitmap where each bit represents a cell, and a value of the bit represents whether the corresponding cell serves the user equipment

Indication information of data transmission tunnel, which is used to indicate a tunnel used for transmitting data. The tunnel may be a tunnel served by the eighth node, or may also be a tunnel served by other nodes. Furthermore, if the tunnel is used for data transmission, the tunnel is an activated tunnel. The information may include at least one of the following information:

Tunnel configuration information, such as at least one of transport layer address and identification information of tunnel endpoint

Tunnel index information

Tunnel indication information, which may be a bitmap where each bit represents a tunnel, and a value of the bit represents whether the corresponding tunnel transmits user data

Data forwarding indication information, which indicates configuration information required for forwarding data. In an embodiment, the information indicates a tunnel required for transmitting the forwarded data, and the information may include at least one of the following information:

Identification information of an old cell group, which indicates an old cell group to which the forwarded data belongs

Identification information of an old cell, which indicates an old cell to which the forwarded data belongs

Identification information of an old node, which indicates an old node to which the forwarded data belongs

Identification information of a new cell group, which indicates a new cell group to which the forwarded data belongs

Identification information of a new cell, which indicates a new cell to which the forwarded data belongs

Identification information of a new node, which indicates a new node to which the forwarded data belongs

Data identification information, which identifies the forwarded data. In an embodiment, if the data is a PDU session of the user equipment, the identification information is an identification of the PDU session; in another embodiment, if the data is a QoS flow of the user equipment, the identification information is an identification of the QoS flow; in another embodiment, if the data is a radio bearer of the user equipment (such as a Data Radio Bearer (DRB)), the identification information is an identification of the RB

Tunnel identification information, which identifies a tunnel required for transmitting data

Third configuration information of data, which indicates configuration information on other node side, including at least one of the transport layer address and the identification information of the tunnel endpoint. The other node may be a node indicated by the above-mentioned “identification information of a new node” or a node serving the above-mentioned “new cell group” or “new cell”

Third configuration information of uplink data, which indicates configuration information on other node side, including at least one of the transport layer address and the identification information of the tunnel endpoint. The other node may be a node indicated by the above-mentioned “identification information of a new node” or a node serving the above-mentioned “new cell group” or “new cell”

Third configuration information of downlink data, which indicates configuration information on other node side, including at least one of the transport layer address and the identification information of the tunnel endpoint. The other node may be a node indicated by the above-mentioned “identification information of a new node” or a node serving the above-mentioned “new cell group” or “new cell”

Indication information of last data packet, which is used to inform the ninth node (i.e., the receiving node) whether the data packet is the last data packet transmitted by the eighth node

In the above information, the “old cell group” or “old cell” or “old node” belongs to a node serving the user equipment before the node change occurs, and the “new cell group” or “new cell” or “new node” belongs to a node serving the user equipment after the node change occurs.

Step 2-2-2: The ninth node operates according to the configuration information received in the above step 2-2-1, and optionally transmits an eleventh message to the eighth node. The eleventh message may be a fifth configuration response message. The possible behaviors of the ninth node include the following:

If the ninth node is a node that directly serves the user equipment (such as a node that performs data transmission with the user equipment through an air interface), the ninth node may determine, according to the configuration information, whether to perform data transmission with the user equipment, whether to perform data transmission with other nodes that serve the user equipment

If the ninth node is a node that directly serves the user equipment (e.g., a node that performs data transmission with the user equipment through an air interface), the ninth node may also transmit configuration information of nodes serving the user equipment to the user equipment, and the user equipment may determine the serving nodes through this information

If the ninth node is not a node that directly serves the user equipment (such as a node that does not perform data transmission with the user equipment through an air interface), the ninth node may transmit the configuration information of the nodes serving the user equipment to other nodes according to the received configuration information

In the above process, the fifth configuration request message may be a message of an Xn/X2/F1/E1 interface, such as a S-Node Addition/Modification Request message, an SgNB Addition/Modification Request message, a UE Context Setup/Modification Request message, a Bearer Context Setup/Modification Request message; the fifth configuration response message may be a message of an Xn/X2/F1/E1 interface, such as a S-Node Addition/Modification Response message, an SgNB Addition/Modification Response message, a UE Context Setup/Modification Response message, a Bearer Context Setup/Modification Response message, or may also be a message of the user plane portion, for example, the information contained in this message may be carried in the data packet of an Xn-U/X2-U/F1-U interface, or they may also be other messages.

The above process has the beneficial effect that the eighth node may configure and/or transmit configuration information related to the nodes serving the user equipment, which is in turn helpful to determine the nodes serving the user equipment. In addition, the process may dynamically change the nodes serving the user equipment, so as to quickly carry out the change and handover of the serving nodes, to improve the efficiency of user data transmission and to reduce the signaling overhead in the procedure of the change and handover of the nodes serving the user equipment.

According to the different types of the eighth node and the ninth node, the above process may be implemented as the following implementations:

Implementation 1 (directly configuring distributed unit serving user equipment)

In this implementation, the ninth node is a distributed unit serving the user equipment through the air interface, and the eighth node is a node different from the ninth node (such as a base station, or a control plane portion of a central unit of the base station, or a user plane portion of a central unit of the base station, or other distributed units, or a node serving PDCP layer of user data (such as a PDCP hosting node)). The eighth node may belong to the same base station as the ninth node, or it may belong to a different base station from that of the ninth node. The process of this implementation is as follows:

Step 2-2-a1: The eighth node (such as a central unit of the base station, or a control plane portion of the central unit of the base station, or a user plane portion of the central unit of the base station, or a node serving PDCP layer of user data (such as a PDCP hosting node)) transmits a fifth configuration request message to the ninth node (a distributed unit of the base station). The contents of this message may be referred to the above step 2-2-1

Step 2-2-a2: The ninth node determines whether to serve the user equipment, or may also determine whether to transmit data to other nodes, or may also configure the user equipment so as to let the user equipment determines the serving nodes

In an example of this implementation, the eighth node is a node serving the PDCP layer of user data (such as a central unit of a base station or a user plane portion of the central unit of a base station), and the ninth node is a distributed unit serving the user equipment (the distributed unit changes from not serving the user equipment to serving the user equipment or from serving the user equipment to not serving the user equipment, through the configuration procedure); in another example, the eighth node is one distributed unit serving user data, and the ninth node is another distributed unit serving user data. Through the above process, the eighth node is changed from serving the user equipment to not serving the user equipment, while the ninth node is changed from not serving the user equipment to serving the user equipment. Further, the process may be performed through data packets in the user plane portion.

Implementation 2 (transmitting the determined configuration information of nodes serving the user equipment to other nodes)

In this implementation, the eighth node determines the nodes serving the user equipment. The eighth node may be a base station (or a central unit of the base station, or a control plane portion of the central unit of the base station) in dual connectivity or multi connectivity, or a central unit (or a control plane portion of the central unit) connected with a plurality of distributed units serving the user equipment. In an embodiment, the base station is a master base station, and in another embodiment, the base station is a secondary base station, and the ninth node is not a node directly serving the user equipment. In an implementation, the eighth node is a base station (or a central unit of the base station, or a control plane portion of the central unit of the base station, or a user plane portion of the central unit of the base station; in an embodiment, the base station is a master base station, in another embodiment, the base station is a secondary base station, and in another embodiment, the base station is a base station to which a node serving the PDCP layer of user data belongs) in dual connectivity or multi connectivity, the ninth node is a node serving the PDCP layer of user data (e.g., a PDCP hosting node), and the process of this implementation may be referred to the above steps 2-2-1 and 2-2-2. In this process, the ninth node also needs to forward the received configuration information to other nodes (such as nodes serving the user equipment, or a central unit of the base station to which the node serving the user equipment belongs, or a control plane portion of the central unit, or the user plane portion of the central unit).

A typical example in this implementation is that the master base station (or a central unit of the master base station, or a control plane portion of the central unit of the master base station) in dual connectivity or multi-connectivity transmits the fifth configuration request message to the central unit (or the control plane portion of the central unit) of the base station to which the node serving the PDCP layer of the user data belongs. In this example, the serving node for the user equipment is determined by the master base station. Another typical example is that the central unit (or the control plane portion of the central unit) of the base station to which the node serving the PDCP layer of the user data belongs transmits the fifth configuration request message to the node (such as a user plane portion of the central unit of the base station) serving the PDCP layer of the user data. In this example, the serving node for the user equipment is a central unit or a control plane portion of the central unit of the base station to which the node serving the PDCP layer of the user data belongs.
3) Process 3: A process for configuring the user equipment

In the procedure of dynamically changing the nodes serving the user equipment, it is also necessary to configure the user equipment. The process 3 mainly involves configuring the user equipment, and the nodes involved are:

Tenth node: this node transmits configuration information to the user equipment, this node may be a base station, or may also be a central unit of the base station, or may also be a control plane portion of the central unit of the base station, or may also be a distributed unit of the base station.

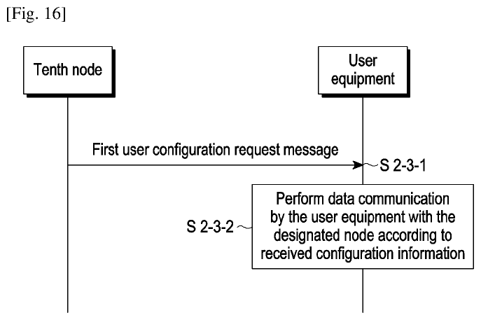

FIG. 16 is an example process for configuring a user equipment according to an example embodiment of the present disclosure. As shown in FIG. 16, the process may include the following steps:

Step 2-3-1: The tenth node transmits a twelfth message to the user equipment. The twelfth message may be a first user configuration request message, which is used to configure the user equipment. The information may include at least one of the following information:

Data identification information: in an embodiment, if the data is a PDU session of the user equipment, the identification information is an identification of the PDU session; in another embodiment, if the data is a QoS flow of the user equipment, the identification information is an identification of the QoS flow; and in another embodiment, if the data is a radio bearer of the user equipment (such as a Data Radio Bearer (DRB)), the identification information is an identification of the RB

Configuration information of a cell or a cell group serving the user equipment, which is mainly used to configure a cell or a cell group required to serve user data transmission. The information may include at least one of the following information:

Information defined in an Information Element CellGroupConfig defined in traditional technology, see TS38.331

Identification information of data served by the cell or cell group: in one embodiment, if the data is a PDU session of the user equipment, the identification information is an identification of the PDU session; in another embodiment, if the data is a QoS flow of the user equipment, the identification information is an identification of the QoS flow; and in another embodiment, if the data is a radio bearer of the user equipment (such as a Data Radio Bearer (DRB)), the identification information is an identification of the RB

Time advance information, which indicates a time advance required when the user equipment transmits uplink data on the cell or a cell of the cell group

Valid time information of time advance, which is used to indicate valid time of the “time advance information”. During the valid time, the user equipment may use the “time advance information” to transmit uplink data

Configuration information of a node serving the user equipment, which is used to inform the user equipment of which cells being required to transmit data. The information may include at least one of the following information:

Indication information of serving the user equipment, which is used to indicate that the user equipment may transmit data in a cell or a cell group where it is located when receiving the information

Indication information of not serving the user equipment, which is used to indicate that the user equipment may not transmit data in a cell or a cell group where it is located when receiving the information

Indication information of activating a node, which is used to indicate that the user equipment may transmit data in a node connected by it when receiving the information

Indication information of deactivating a node, which is used to indicate that the user equipment may not transmit data in a node connected by it when receiving the information

Indication information of activating a cell group, which is used to indicate that the user equipment may transmit data in a cell or a cell group where it is located when receiving the information

Indication information of deactivating a cell group, which is used to indicate that the user equipment may not transmit data in a cell or a cell group where it is located when receiving the information

Indication information of activating a cell, which is used to indicate that the user equipment may transmit data in a cell where it is located when receiving the information

Indication information of deactivating a cell, which is used to indicate that the user equipment may not transmit data in a cell where it is located when receiving the information

Indication information of a node serving the user equipment, which indicates one or more nodes serving the user equipment. Further, if a node serves the user equipment, it means that the node is an activated node for the user equipment. The information may include at least one of the following information:

Identification information of a node serving the user equipment, which includes identification information of one or more nodes, the node may be a base station, or a distributed unit of the base station, or a central unit of the base station, a control plane portion of the central unit of the base station, or a user plane portion of the central unit of the base station

Identification information of a node that does not serve the user equipment, which includes identification information of one or more nodes, the node may be a base station, or a distributed unit of the base station, or a central unit of the base station, or a control plane portion of the central unit of the base station, or a user plane portion of the central unit of the base station

Node indication information, which may be a bitmap where each bit represents a node, and a value of the bit represents whether the corresponding node serves the user equipment

Indication information of a cell group serving the user equipment, which indicates one or more cell groups serving the user equipment. Further, if a cell group serves the user equipment, it means that the cell group is an activated cell group for the user equipment. The information may include at least one of the following information:

Identification information of a cell group serving the user equipment, which includes identification information of one or more cell groups serving the user equipment

Identification information of a cell group that does not serve the user equipment, which includes identification information of one or more cell groups that do not serve the user equipment

Cell group indication information, which may be a bitmap where each bit represents a cell group, and a value of the bit represents whether the corresponding cell group serves the user equipment

Indication information of a cell serving the user equipment, which indicates one or more cells serving the user equipment. Further, if a cell serves the user equipment, it means that the cell is an activated cell for the user equipment. The information may include at least one of the following information:

Identification information of a cell serving the user equipment, which includes identification information of one or more cells serving the user equipment

Identification information of a cell that does not serve the user equipment, which includes identification information of one or more cells that do not serve the user equipment

Cell indication information, which may be a bitmap where each bit represents a cell, and a value of the bit represents whether the corresponding cell serves the user equipment

Step 2-3-2: The user equipment performs data transmission with the designated node(s) according to the received configuration information.

The first user configuration request message in the above process may be an RRC message, such as an RRCReconfiguration message, or the information contained in the above-mentioned first user configuration request message may also be transmitted to the user equipment through the control information element of the MAC layer, or the information contained in the above-mentioned first user configuration request message may also be transmitted to the user equipment by other means.

The above process has the beneficial effects that the user equipment may dynamically change, according to the configuration information, the cells or nodes where data transmission is performed, and the network side may dynamically change the nodes serving the user equipment according to the channel condition, data characteristics and so on of the user equipment, thereby improving the efficiency of user data transmission and reducing signaling overhead in the procedure of dynamically changing the nodes serving the user equipment.

According to different types of the tenth node, the above process may include the following implementations:

Implementation 1:

In this implementation, the base station or the central unit of the base station, or the control plane portion of the central unit of the base station configures the user equipment through the RRC message, then the first user configuration request message in the above step 2-3-1 may be an RRC message.

Implementation 2:

In this implementation, the base station or the distributed unit of the base station configures the user equipment through the information of the MAC layer, and the information in the first user configuration request message in the above step 2-3-1 may be transmitted to the user equipment through the control information element of the MAC layer.

Third Aspect: Data Forwarding Between Distributed Units of Base Station

This aspect mainly involves data forwarding between two distributed units (a distributed unit 1 and a distributed unit 2).

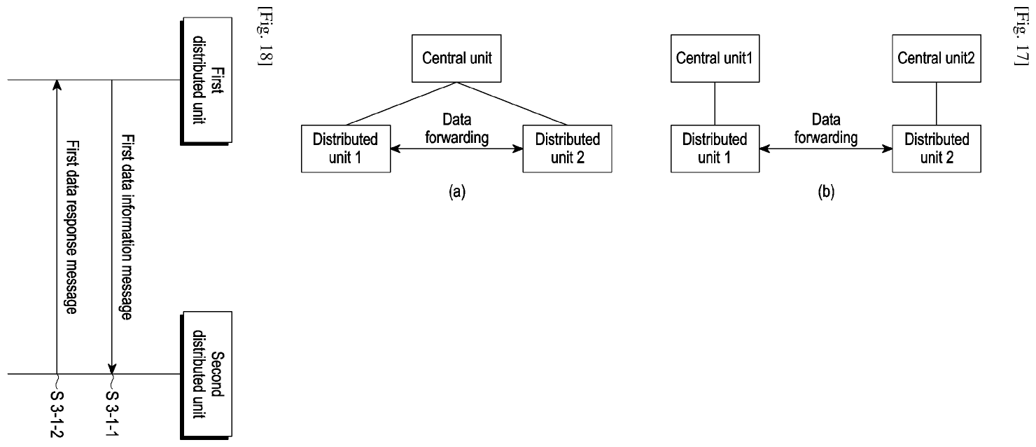

FIG. 17 is a schematic diagram of data forwarding between distributed units of base stations according to an example embodiment of the present disclosure. As shown in FIG. 17, these two distributed units may belong to the same base station (connected with the same central unit) or different base stations (connected with different central units). In an embodiment, the forwarding is the mutual transmission of data between distributed units, so as to complete the transmission of user data. For example, the data transmitted by the user equipment to the distributed unit 1 is transmitted to the distributed unit 2, then transmitted to other nodes (such as the central unit) by the distributed unit 2, and then transmitted to the core network by other nodes. For another example, the data transmitted by the central unit or the user plane portion of the central unit or other base stations to the distributed unit 1 is transmitted to the distributed unit 2, and then transmitted to the user equipment by the distributed unit 2. In another embodiment, the forwarding occurs because the user equipment is handed over from the distributed unit 1 to the distributed unit 2, for example, the node to which the user equipment is connected changes involved in the first aspect of the present invention; in another embodiment, the forwarding occurs because the network side dynamically changes the distributed units serving the user equipment, for example, the nodes of the user equipment dynamically change involved in the second aspect of the present invention. The above data forwarding is different from the traditional technology. In traditional technology, user data forwarding occurs between different base stations, or between central units of different base stations, or between user plane portions of central units of different base stations, or between different user plane portions of the central unit of the same base station, or between the central unit and the distributed unit of the base station, or between user plane portion of the central unit and the distributed unit of the base station, so data forwarding in traditional technology occurs on the X2/Xn/F1 interface. However, the third aspect of the present invention discloses data forwarding between different distributed units. The nodes involved in this aspect include a first distributed unit and a second distributed unit, which may belong to the same base station, or may also belong to different base stations.

FIG. 18 is an example process involved in forwarding of data between distributed units of a base station according to an example embodiment of the present disclosure. As shown in FIG. 18, the data forwarding process involved in this aspect may include the following steps:

Step 3-1-1: The first distributed unit transmits a thirteenth message to the second distributed unit. The thirteenth message may be a first data information message, which is mainly used to forward user data, and/or configuration information related to user data transmission. The message may include at least one of the following information:

Data packet of the user equipment, which may also further implicitly activate data transmission of the second distributed unit with the user equipment

Indication information of the last data packet, which is used to indicate that the first distributed unit will not transmit a data packet to the second distributed unit any more. For example, the information is a Final Frame Indication, an End Marker, and so on

Information related to discarded data packet, which is used to indicate the second distributed unit to discard the data packet. The information may include at least one of the following information:

Identification information of a discarded data packet, such as a PDCP SN, a GTP-U SN, etc., according to which, the second distributed unit may determine a data packet that needs to be discarded

Minimum identification information of discarded data packets, such as a PDCP SN, a GTP-U SN, etc., according to which, the second distributed unit may determine a data packet with the smallest sequence number that needs to be discarded

Maximum identification information of discarded data packets, such as a PDCP SN, a GTP-U SN, etc. according to which, the second distributed unit may determine a data packet with the largest sequence number that needs to be discarded

Indication information of discarded data packets, which may be a Bitmap, where each bit corresponds to a data packet, and a value of each bit indicates whether the corresponding data packet needs to be discarded. This information may be combined with the above-mentioned “minimum identification information of discarded data packet” and/or “maximum identification information of discarded data packet”

Indication information of a discarded data packet group, which indicates one or more groups of data packets with continuous sequence numbers that need to be discarded. For a group of data packets that need to be discarded, the information may include at least one of the following information:

Minimum identification information of discarded data packets, such as a PDCP SN, a GTP-U SN, etc.

Maximum identification information of discarded data packets, such as a PDCP SN, a GTP-U SN, etc.

Number of discarded packets with consecutive sequence numbers

Activation indication information, which is used to indicate that the second distributed unit starts data transmission with the user equipment

Step 3-1-2: Optionally, the second distributed unit transmits a fourteenth message to the first distributed unit. The fourteenth message may be a first data response message, and it is mainly used to provide data reception status information, such as the indication information of correctly received data packets. The information contained in the message may be referred to the Downlink Data Delivery Status (DDDS) message in TS38.425.

The first data information message in the above process may be a data packet of a user plane portion, such as a data packet of a GTP-U. The process has the beneficial effects that different distributed units may transmit data to each other, thus avoiding the process of data forwarding through the central unit or the user plane portion of the central unit required in the traditional technology, reducing the time delay of data transmission and improving the efficiency of data transmission.

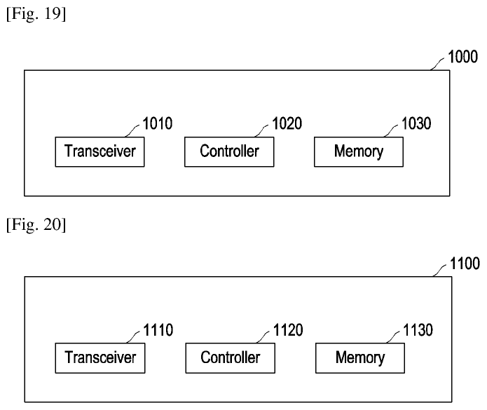

FIG. 19 is a block diagram of a node according to an example embodiment of the present invention. Here, the node is taken as an example to explain its structure and function, but it should be understood that the shown structure and function may also be applied to a base station (or a central unit of the base station, or a control plane portion of the central unit of the base station, or a user plane portion of the central unit of the base station, or a distributed unit of the base station, etc.).

Referring to FIG. 19, the node 1000 includes a transceiver 1010, a controller 1020 and a memory 1030. Under the control of the controller 1020 (which may be implemented as one or more processors), the node 1000 (including the transceiver 1010 and the memory 1030) is configured to execute the operations of the node in the process shown in FIGS. 7-12, 14-16, and 18 or described above. Although the transceiver 1010, the controller 1020 and the memory 1030 are shown as separate entities, they may be implemented as a single entity, such as a single chip. The transceiver 1010, the controller 1020, and the memory 1030 may be electrically connected or coupled to each other. Transceiver 1010 may transmit and receive signals to and from other network entities, such as another node and/or UE, etc. In an implementation, the transceiver 1010 may be omitted. In this case, the controller 1020 may be configured to execute instructions (including computer programs) stored in the memory 1030 to control the overall operation of the node 1000, thereby realizing the operations of the nodes in the process shown in FIGS. 7-12, 14-16, and 18 or described above.

FIG. 20 is a block diagram of a user equipment according to an example embodiment of the present invention.

Referring to FIG. 20, the user equipment 1100 includes a transceiver 1110, a controller 1120 and a memory 1130. Under the control of the controller 1120 (which may be implemented as one or more processors), the user equipment 1100 (including the transceiver 1110 and the memory 1130) is configured to perform the operations of the user equipment in the process shown in FIGS. 11-12 and 16 or described above. Although the transceiver 1110, the controller 1120 and the memory 1130 are shown as separate entities, they may be implemented as a single entity, such as a single chip. The transceiver 1110, the controller 1120, and the memory 1130 may be electrically connected or coupled to each other. The transceiver 1110 may transmit and receive signals to and from other network entities, such as a node, another UE, etc. In an implementation, the transceiver 1110 may be omitted. In this case, the controller 1120 may be configured to execute instructions (including computer programs) stored in the memory 1130 to control the overall operation of the user equipment 1100, so as to perform the operations of the user equipment in the process shown in FIGS. 11-12 and 16 or described above.

Those skilled in the art may recognize that the present invention may be realized in other specific forms without changing the technical idea or essential feature of the present invention. Therefore, it should be understood that the above embodiments are only examples and are not limited. The scope of the invention is defined by the accompanying claims, not by the detailed description. Therefore, it should be understood that all modifications or changes derived from the meaning and scope of the accompanying claims and their equivalents are within the scope of the present invention.

In the above embodiments of the present invention, all operations and messages may be selectively performed or may be omitted. In addition, the operations in each embodiment need not be performed in sequence, and the order of operations may be changed. Messages do not need to be transmitted in order, and the transmission order of messages may change. Each operation and each message transmission may be performed independently.

While the invention has been shown and described with reference to various embodiments thereof, it will be understood by those skilled in the art that various changes in form and details may be made without departing from the spirit and scope of the invention as defined by the accompanying claims and their equivalents.

1. A method performed by a node connected by a user equipment in multi-connectivity in a wireless communication system, comprising:
transmitting, to a target node connected by the user equipment, a first message including information related to user equipment configuration;
receiving, from the target node, a second message including configuration information on the target node;
transmitting, to a source node connected by the user equipment, a fourth message is used to configure the source node to perform data transmission with the user equipment in a procedure of change of the node connected by the user equipment; and
receiving, from the source node, a fifth message including configuration information related to user data transmission at the source node.

2. The method according to claim 1,
wherein the first message includes at least one of information for requesting the target node that the user equipment also performs data transmission with the source node, information for requesting forwarding data to the target node, and first configuration information related to user data;
the second message includes at least one of information for indicating whether the target node accepts the request, configuration information generated by the target node for data transmission required by the user equipment, and second configuration information related to user data;
the fourth message includes at least one of indication information of data transmission behavior and third configuration information related to user data; and
the fifth message includes fourth configuration information related to user data.

3. The method of claim 1, further comprising:
receiving, from the target node, a third message for indicating that the user equipment has accessed the target node.

4. A method performed by a source node connected by a user equipment in a wireless communication system, comprising:
receiving, from a node connected by a user equipment in multi-connectivity, a fourth message used to configure is a source node connected by the user equipment to perform data transmission with the user equipment in a procedure of change of the node connected by the user equipment; and
transmitting, to the node, a fifth message including configuration information related to user data transmission at the source node,
wherein a first message is transmitted from the node to a target node connected by the user equipment,
wherein a second message is transmitted from the target node to the node, and
wherein the first message includes information related to user equipment configuration, the second message includes configuration information on the target node.

5. The method according to claim 4,
wherein the first message includes at least one of information for requesting the target node that the user equipment also performs data transmission with the source node, information for requesting forwarding data to the target node, and first configuration information related to user data;
the second message includes at least one of information for indicating whether the target node accepts the request, configuration information generated by the target node for data transmission required by the user equipment, and second configuration information related to user data;
the fourth message includes at least one of indication information of data transmission behavior and third configuration information related to user data; and
the fifth message includes fourth configuration information related to user data.

6. A method performed by a target node connected by a user equipment in a wireless communication system, comprising:
receiving, from a node connected by the user equipment in multi-connectivity, a first message including information related to user equipment configuration; and
transmitting, to the node, a second message including configuration information on a target node connected by the user equipment,
wherein a fourth message is transmitted from the node to a source node connected by the user equipment,
wherein a fifth message is transmitted from the source node to the node, and
wherein the fourth message is used to configure the source node to perform data transmission with the user equipment in a procedure of change of a node connected by the user equipment, and the fifth message includes configuration information related to user data transmission at the source node.

7. The method according to claim 6, further comprising:
transmitting, to the node, a third message for indicating that the user equipment has accessed the target node.

8. The method according to claim 6,
wherein the first message includes at least one of information for requesting the target node that the user equipment also performs data transmission with the source node, information for requesting forwarding data to the target node, and first configuration information related to user data;
the second message includes at least one of information for indicating whether the target node accepts the request, configuration information generated by the target node for data transmission required by the user equipment, and second configuration information related to user data;
the fourth message includes at least one of indication information of data transmission behavior and third configuration information related to user data; and
the fifth message includes fourth configuration information related to user data.

9. A node connected by a user equipment in multi-connectivity in a wireless communication system, the node comprising:
a transceiver; and
a controller coupled with the transceiver and configured to control to:
transmit, to a target node connected by the user equipment, a first message including information related to user equipment configuration,
receive, from the target node, a second message including configuration information on the target node,
transmit, to a source node connected by the user equipment, a fourth message is used to configure the source node to perform data transmission with the user equipment in a procedure of change of the node connected by the user equipment, and
receive, from the source node, a fifth message including configuration information related to user data transmission at the source node.

10. The node according to claim 9,
wherein the first message includes at least one of information for requesting the target node that the user equipment also performs data transmission with the source node, information for requesting forwarding data to the target node, and first configuration information related to user data;
the second message includes at least one of information for indicating whether the target node accepts the request, configuration information generated by the target node for data transmission required by the user equipment, and second configuration information related to user data;
the fourth message includes at least one of indication information of data transmission behavior and third configuration information related to user data; and
the fifth message includes fourth configuration information related to user data.

11. The node of claim 9, wherein the controller is configured to control to:
receive, from the target node, a third message for indicating that the user equipment has accessed the target node.

12. A source node connected by a user equipment in a wireless communication system, the source node comprising:
a transceiver; and
a controller coupled with the transceiver and configured to control to:
receive, from a node connected by a user equipment in multi-connectivity, a fourth message used to configure is a source node connected by the user equipment to perform data transmission with the user equipment in a procedure of change of the node connected by the user equipment; and
transmit, to the node, a fifth message including configuration information related to user data transmission at the source node,
wherein a first message is transmitted from the node to a target node connected by the user equipment,
wherein a second message is transmitted from the target node to the node, and
wherein the first message includes information related to user equipment configuration, the second message includes configuration information on the target node.

13. The source node according to claim 12,
wherein the first message includes at least one of information for requesting the target node that the user equipment also performs data transmission with the source node, information for requesting forwarding data to the target node, and first configuration information related to user data;
the second message includes at least one of information for indicating whether the target node accepts the request, configuration information generated by the target node for data transmission required by the user equipment, and second configuration information related to user data;
the fourth message includes at least one of indication information of data transmission behavior and third configuration information related to user data; and
the fifth message includes fourth configuration information related to user data.

14. A target node connected by a user equipment in a wireless communication system, the target node comprising:
a transceiver; and
a controller coupled with the transceiver and configured to control to:
receive, from a node connected by the user equipment in multi-connectivity, a first message including information related to user equipment configuration, and
transmit, to the node, a second message including configuration information on a target node connected by the user equipment,
wherein a fourth message is transmitted from the node to a source node connected by the user equipment,
wherein a fifth message is transmitted from the source node to the node, and
wherein the fourth message is used to configure the source node to perform data transmission with the user equipment in a procedure of change of a node connected by the user equipment, and the fifth message includes configuration information related to user data transmission at the source node.

15. The target node according to claim 14, wherein the controller is configured to control to:
transmit, to the node, a third message for indicating that the user equipment has accessed the target node.
